(19) United States
(12) Patent Application Publication
(10) Pub. No.: US 2014/0294539 A1
(43) Pub. Date: Oct. 2, 2014

(54) Bookbinding Apparatus

(71) Applicant: Brother Kogyo Kabushiki Kaisha, Nagoya-shi (JP)

(72) Inventors: Masato Kato, Kasugai-shi (JP); Kazuma Hojo, Inazawa-shi (JP); Hiroshi Takami, Nagoya-shi (JP); Minoru Yamamoto, Nagoya-shi (JP); Koshiro Yamaguchi, Kakamigahara-shi (JP)

(73) Assignee: Brother Kogyo Kabushiki Kaisha, Nagoya-shi (JP)

(21) Appl. No.: 14/227,033

(22) Filed: Mar. 27, 2014

(30) Foreign Application Priority Data
Mar. 29, 2013 (JP) 2013-075321
Mar. 29, 2013 (JP) 2013-075330
Mar. 29, 2013 (JP) 2013-075362

(51) Int. Cl. B42C 11/04

(52) U.S. Cl. CPC B42C 11/04
USPC 412/21

(57) ABSTRACT

A conveyance portion is configured to hold a bundle of paper sheets, the bundle of paper sheets being a plurality of paper sheets stacked in a first direction, and also configured to convey the bundle of paper sheets in a second direction. An adhesive portion forming portion is configured to form an adhesive portion on an end face, in the second direction, of the bundle of paper sheets. A cover sheet holding portion is configured to hold a cover sheet in a state in which the cover sheet and the adhesive portion face each other in the second direction. The bundle of paper sheets is conveyed by the conveyance portion toward a contact position where the adhesive portion comes into contact with the cover sheet.

### CROSS-REFERENCE TO RELATED APPLICATION

This application claims priority to Japanese Patent Applications No. 2013-75321, filed Mar. 29, 2013, No. 2013-75330, filed Mar. 29, 2013, and No. 2013-75362, filed Mar. 29, 2013. The disclosure of the foregoing applications is incorporated herein by reference in its entirety.

### BACKGROUND

The present disclosure relates to a bookbinding apparatus that performs case binding.

In related art, a bookbinding apparatus is known that performs case binding in which a bundle of paper sheets is cased into a cover sheet and a book is bound. For example, in a known bookbinding apparatus, intermediate paper sheets that are accumulated by an accumulation mechanism are conveyed in the horizontal direction toward a vertical conveyance path. Two cover sheets are supplied from a cover sheet supply mechanism to the vertical conveyance path. A side edge of the supplied two cover sheets is adhered to a side edge of the intermediate paper sheets using a bookbinding tape. Further, a cover that covers the two cover sheets is supplied from a cover supply mechanism to the vertical conveyance path. The intermediate paper sheets, to which the two cover sheets have been adhered, are conveyed in the horizontal direction toward the supplied cover, and are cased into the cover.

### SUMMARY

The known bookbinding apparatus has a complicated and large structure in order to accurately perform case binding. Various embodiments of the broad principles derived herein provide a bookbinding apparatus that is configured to accurately perform case binding with a simple and compact structure.

Various embodiments herein provide a bookbinding apparatus that includes a conveyance portion, an adhesive portion forming portion, a cover sheet supply portion, a cover sheet holding portion, a processor, and a memory. The conveyance portion is configured to hold a bundle of paper sheets, the bundle of paper sheets being a plurality of paper sheets stacked in a first direction, and also configured to convey the bundle of paper sheets in a second direction. The second direction is a direction orthogonal to the first direction. The first direction includes a third direction and a fourth direction that are directions opposite to each other. The adhesive portion forming portion is configured to form an adhesive portion on an end face, in the second direction, of the bundle of paper sheets held by the conveyance portion. The cover sheet supply portion is configured to supply a cover sheet that is configured to cover the bundle of paper sheets to a predetermined supply position. The cover sheet holding portion is configured to hold the cover sheet supplied to the supply position by the cover sheet supply portion in a state in which the cover sheet and the adhesive portion formed by the adhesive portion forming portion face each other in the second direction. The cover sheet holding portion includes a first holding portion, a second holding portion and a movement portion. The first holding portion is configured to hold the cover sheet supplied to the supply position on the third direction side with respect to a contact position. The second holding portion is provided on the fourth direction side with respect to the first holding portion and is configured to hold the cover sheet supplied to the supply position on the fourth direction side with respect to the contact position. The movement portion is configured to move at least one of the first holding portion and the second holding portion in the first direction. The contact position is a position where the adhesive portion comes into contact with the cover sheet. The memory stores computer-readable instructions, the computer-readable instructions, when executed by the processor, causing the processor to perform processes comprising causing the conveyance portion to convey the bundle of paper sheets toward the contact position in a state in which the cover sheet is held by the cover sheet holding portion.

Various embodiments herein also provide a bookbinding apparatus that includes a table, a paper alignment portion, and an application portion. The table has a placement surface which extends in a horizontal direction. The placement surface is configured to hold a bundle of paper sheets on the placement surface. The bundle of paper sheets is the plurality of paper sheets held on the placement surface and stacked in an up-down direction that is orthogonal to the horizontal direction. The paper alignment portion has a surface portion that extends in the up-down direction. The surface portion is configured to come into contact with an end face of the bundle of paper sheets and is configured to align the end face of the bundle of paper sheets to be in a substantially same plane along the up-down direction within a predetermined area. The end face of the bundle of paper sheets is an end face of the bundle of paper sheets in a first direction that is included in the horizontal direction. The predetermined area is an area along a second direction. The second direction is a direction orthogonal to the up-down direction and to the first direction. The application portion is configured to form an adhesive portion on the end face of the bundle of paper sheets aligned by the paper alignment portion, by applying an adhesive to the bundle of paper sheets from the first direction side within the predetermined area. The adhesive portion is a portion to which a cover sheet that is configured to cover the bundle of paper sheets can be adhered.

Various embodiments herein also provide a bookbinding apparatus that includes a table, a binding portion, and a cutting portion. The table has a placement surface that is a flat surface configured to hold a bundle of paper sheets. The table is configured to move parallel to the placement surface along a conveyance path. The bundle of paper sheets is a plurality of paper sheets held on the placement surface and stacked in an orthogonal direction that is orthogonal to the placement surface. The conveyance path passes through a supply position where the plurality of paper sheets are supplied to the table. The table is configured to move in a first direction toward a binding position and to move in a second direction toward a cutting position. The first direction is a direction extending parallel to the placement surface. The second direction is a direction opposite to the first direction. The binding portion is provided on the first direction side with respect to the supply position and is configured to bind a first end face. The first end face is an end face of the bundle of paper sheets in the first direction. The binding position is a position where the first end face is bound by the binding portion. The cutting portion is provided on the second direction side with respect to the supply position and is configured to cut off at least a second end face in the orthogonal direction. The second end face is an end face of the bundle of paper sheets in the second direction. The cutting position is a position where the second end face is cut off by the cutting portion.

### BRIEF DESCRIPTION OF THE DRAWINGS

Embodiments of the present disclosure will be described below in detail with reference to the accompanying drawings in which:

FIG. 1 is a perspective view of a bookbinding apparatus as viewed from above the front right side;

FIG. 2 is a front view of the bookbinding apparatus;

FIG. 3 is a right side view of the bookbinding apparatus;

FIG. 4 is a perspective view of a first printer, a paper sheet supply portion and a table, as viewed from above the front left side;

FIG. 5 is a perspective view showing a paper alignment unit, a bundle operation unit and a gluing unit, as viewed from above the rear right side;

FIG. 6 is a schematic front view of a movable portion and its peripheral portion;

FIG. 7 is a left side view of the paper alignment unit and the bundle operation unit;

FIG. 8 is a perspective view of the movable portion as viewed from above the rear left side;

FIG. 9 is a vertical cross-sectional view of the movable portion;

FIG. 10 is a left side view of a second printer, a cover sheet supply portion and a cover sheet holding unit in an initial state;

FIG. 11 is a perspective view of the movable portion in the initial state, as viewed from above the rear right side;

FIG. 12 is a plan view of the movable portion;

FIG. 13 is a partially enlarged plan view of an upper clamp when an operation area is opened;

FIG. 14 is a partially enlarged plan view of the upper clamp when the operation area is closed;

FIG. 15 is a right side view of the bundle operation unit, a cutting unit and the table before a book is supplied to the cutting unit;

FIG. 16 is a perspective view of the cutting unit as viewed from above the front right side;

FIG. 17 is a left side view of the bookbinding apparatus in which paper alignment of a bundle of paper sheets is performed;

FIG. 18 is a left side view of the second printer, the cover sheet supply portion and the cover sheet holding unit when a cover sheet is received;

FIG. 19 is a left side view of the second printer, the cover sheet supply portion and the cover sheet holding unit when the cover sheet is conveyed;

FIG. 20 is a left side view of the cover sheet holding unit in which the cover sheet is held;

FIG. 21 is a left side view of the bookbinding apparatus in which the bundle of paper sheets is glued;

FIG. 22 is a left side view of the bookbinding apparatus in which the bundle of paper sheets is cased into the cover sheet;

FIG. 23 is a perspective view of the movable portion as viewed from above the rear right side;

FIG. 24 is a left side view of the bookbinding apparatus in which the table is separated from the book;

FIG. 25 is a left side view of the bookbinding apparatus in which the book is lifted;

FIG. 26 is a left side view of the bookbinding apparatus in which the book is placed on the table;

FIG. 27 is a right side view of the bundle operation unit, the cutting unit and the table when the book is supplied to the cutting unit;

FIG. 28 is a plan view of the cutting unit to which the book has been supplied;

FIG. 29 is a plan view of the cutting unit when the left end face and the right end face of the book are cut off; and

FIG. 30 is a plan view of the cutting unit when the rear end face of the book is cut off.

### DETAILED DESCRIPTION

### 1. Schematic Structure of Bookbinding Apparatus 1

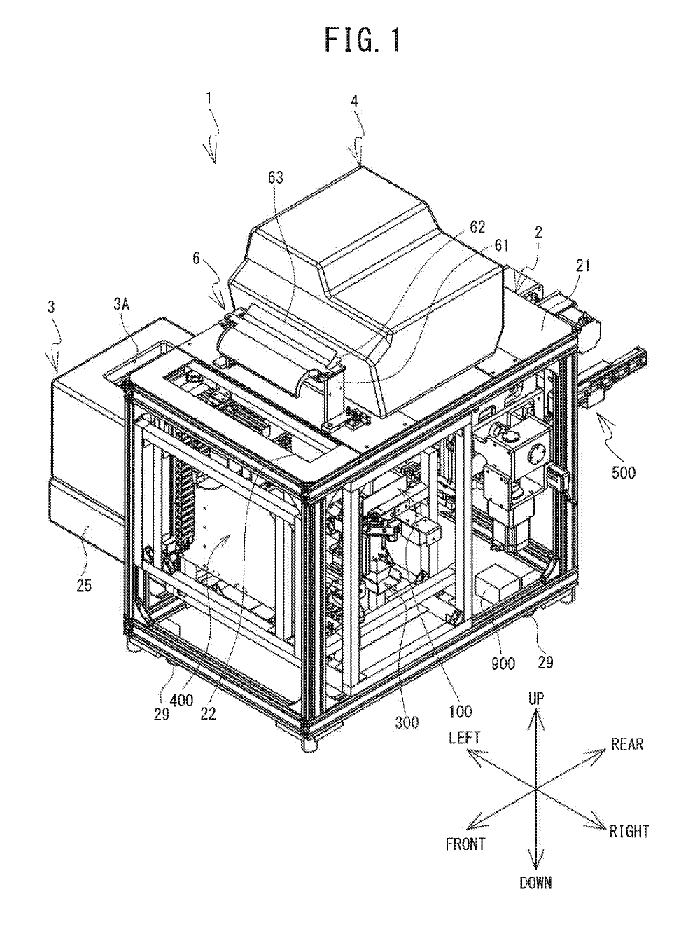

The schematic structure of the bookbinding apparatus 1 will be explained with reference to FIG. 1 to FIG. 3. In the explanation below, the lower left side, the upper right side, the upper left side, the lower right side, the upper side and the lower side of FIG. 1 are respectively defined as the front side, the rear side, the left side, the right side, the upper side and the lower side of the bookbinding apparatus 1. The up-down direction of the bookbinding apparatus 1 is the same as the vertical direction that is parallel to the direction of gravitational force. The front-rear and left-right directions of the bookbinding apparatus 1 are the same as the horizontal directions that are orthogonal to the direction of the gravitational force. FIG. 1 to FIG. 3 show a state (an initial state) before the bookbinding apparatus 1 starts a bookbinding operation.

The bookbinding apparatus 1 includes a main body frame 2, a first printer 3, a second printer 4, a paper sheet supply portion 5, a cover sheet supply portion 6, a paper alignment unit 100, a bundle operation unit 200, a gluing unit 300, a cover sheet holding unit 400, a cutting unit 500 and a control portion 900. The main body frame 2 has a cuboid frame structure. The main body frame 2 is configured such that the length in the up-down direction is substantially the same as the length in the left-right direction and the long side extends in the front-rear direction.

A mounting stand 25 is coupled and fixed to a lower left frame of the main body frame 2 using metal fittings (not shown in the drawings). The mounting stand 25 is a plate-like body having a substantially square shape in a plan view, and extends to the left from the lower left frame of the main body frame 2. The first printer 3 is placed on the mounting stand 25. That is, the first printer 3 is arranged to the left of the main body frame 2. A top plate 21 is a plate-like body that covers the top surface of the main body frame 2. The second printer 4 is placed on the top plate 21. That is, the second printer 4 is arranged above the main body frame 2. The first printer 3 and the second printer 4 are each arranged substantially in the center of the bookbinding apparatus 1 in the front-rear direction.

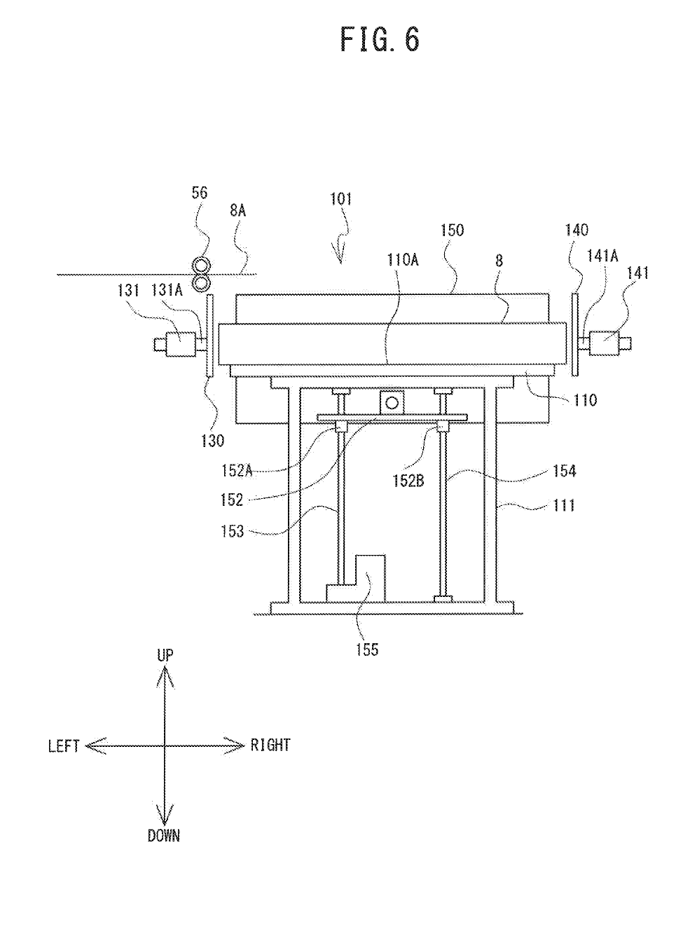

The first printer 3 is a printer that prints a plurality of paper sheets 8A (refer to FIG. 6) that form the content (or text) of a book that is made by the bookbinding apparatus 1. The first printer 3 has a paper sheet discharge opening 3A that is an opening from which the paper sheets printed by the first printer 3 are discharged. In the present embodiment, the first printer 3 is a laser printer that can print images at high speed on thin and standard size paper sheets (normal A4 size paper, for example) suitable for the content of the book. The paper sheet discharge opening 3A is provided in the top surface of the first printer 3, and discharges the printed paper sheets 8A to the upper right direction.

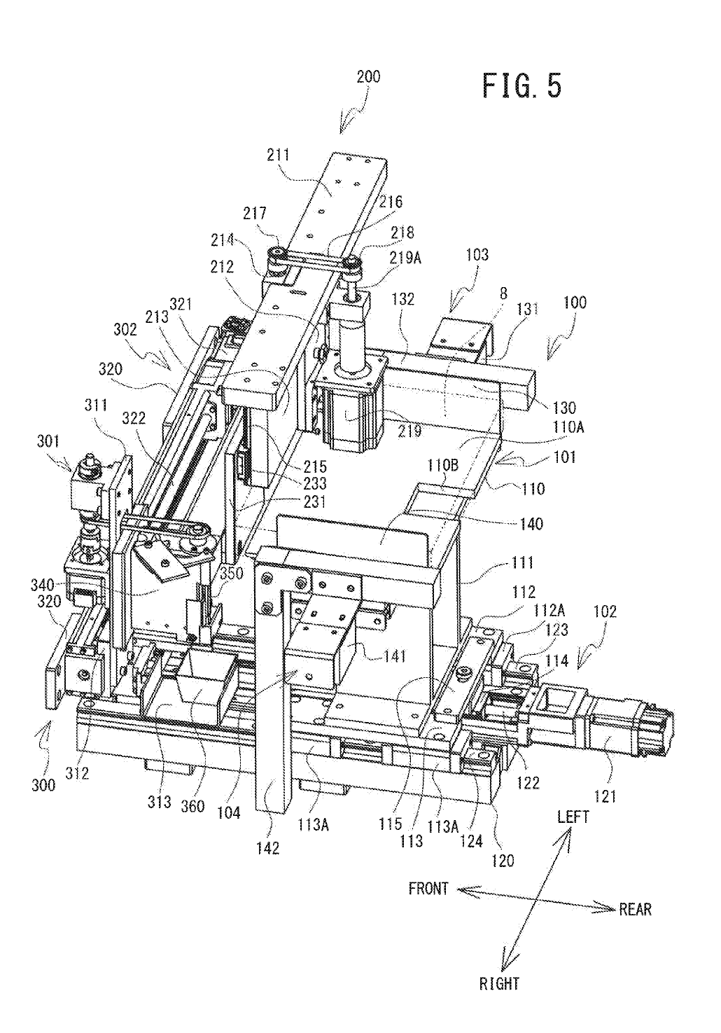

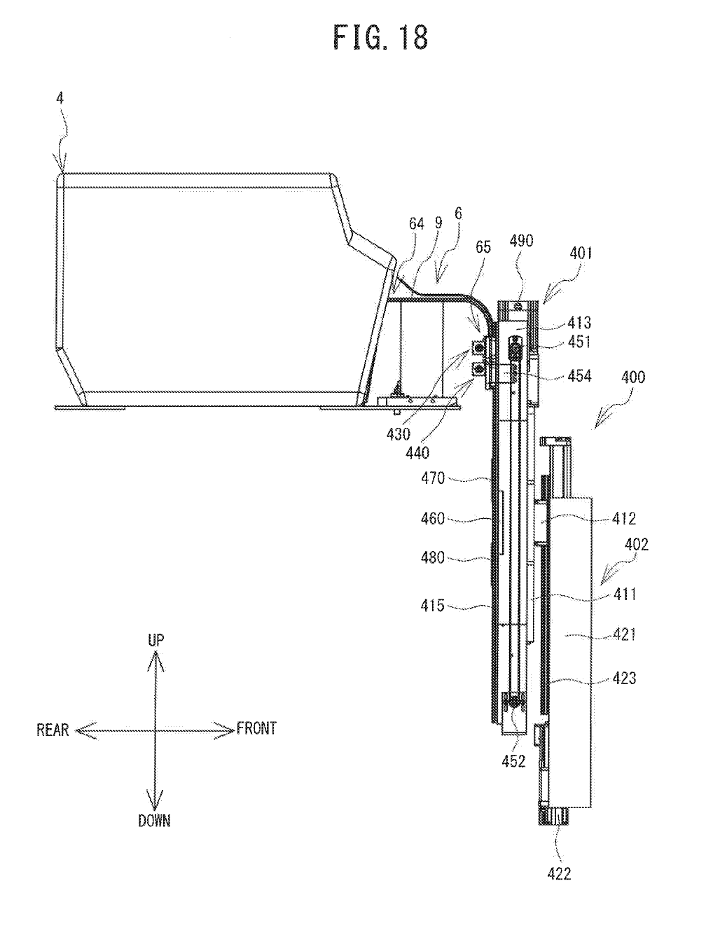

The second printer 4 is a printer that prints a cover sheet 9 (refer to FIG. 18) of a book that is made by the bookbinding apparatus 1. The cover sheet 9 has a size and shape that can cover a bundle of paper sheets 8 (refer to FIG. 5) in which the plurality of paper sheets 8A, which form the content of the book, are stacked. The second printer 4 has a cover sheet discharge opening 4A that is an opening from which the cover sheet 9 printed by the second printer 4 is discharged. In the present embodiment, the second printer 4 is an inkjet printer that can print images with a high image quality on a thick and large size paper sheet (special A3 size paper, for example) that is suitable for the cover sheet. The cover sheet discharge opening 4A is provided on the front surface of the second printer 4, and discharges the printed cover sheet 9 in the forward direction.

The paper sheet supply portion 5 extends from the paper sheet discharge opening 3A toward the inside of the main body frame 2. The paper sheet supply portion 5 supplies the printed paper sheets 8A, which have been discharged from the paper sheet discharge opening 3A, to the paper alignment unit 100 from the left side of the main body frame 2. A cover sheet supply opening 22 is provided in a front edge portion of the top plate 21. The cover sheet supply opening 22 is a rectangular opening which extends in the left-right direction and which penetrates the top plate 21 in the up-down direction. The cover sheet supply opening 22 is located further to the front than the second printer 4. The cover sheet supply portion 6 is provided on the top plate 21, and is located between the cover sheet supply opening 22 and the second printer 4. The cover sheet supply portion 6 supplies the printed cover sheet 9, which has been discharged from the cover sheet discharge opening 4A, to the cover sheet holding unit 400.

The paper alignment unit 100, the bundle operation unit 200, the gluing unit 300, the cover sheet holding unit 400, the cutting unit 500 and the control portion 900 are arranged inside the main body frame 2. However, a part of the cutting unit 500 protrudes to the rear of the main body frame 2. A part of the cover sheet holding unit 400 can move to the upper side of the main body frame 2 via the cover sheet supply opening 22, as described later.

The paper alignment unit 100 is a mechanism that holds and aligns the bundle of paper sheets 8 in which the plurality of paper sheets 8A supplied from the paper sheet supply portion 5 are stacked. The paper alignment of the bundle of paper sheets 8 is an operation in which bundle end faces are aligned to be substantially flush with one another along the direction (the up-down direction, in the present embodiment) in which the plurality of paper sheets 8A are stacked. The bundle end faces are end faces of the bundle of paper sheets 8 in the directions (the front-rear direction and the left-right direction, in the present embodiment) that are orthogonal to the direction in which the plurality of paper sheets 8A are stacked. The bundle operation unit 200 is a mechanism that performs various operations (for example, paper alignment, retaining and conveyance etc.) on the bundle of paper sheets 8 held by the paper alignment unit 100.

The gluing unit 300 is a mechanism that forms an adhesive portion to which the cover sheet 9 can be adhered, on the bundle end face that has been aligned. The cover sheet holding unit 400 is a mechanism which holds the cover sheet 9 supplied from the cover sheet supply portion 6 and which covers the bundle of paper sheets 8 with the held cover sheet 9. The cutting unit 500 is a mechanism that cuts off the bundle end face (of the bundle of paper sheets 8 cased into the cover sheet 9) to which the cover sheet 9 is not adhered. The control portion 900 is a controller that includes a CPU, a ROM, a RAM and the like (which are not shown in the drawings). The CPU controls the bookbinding operation of the bookbinding apparatus 1 based on programs that are stored in the ROM.

As described above, the first printer 3, the second printer 4, the paper sheet supply portion 5, the cover sheet supply portion 6, the paper alignment unit 100, the bundle operation unit 200, the gluing unit 300, the cover sheet holding unit 400, the cutting unit 500 and the control portion 900 are all supported by the main body frame 2. A user can integrally move the bookbinding apparatus 1 via a plurality of casters 29 that are provided on the four corners of the lower surface of the main body frame 2.

### 2. Detailed Structure of Paper Sheet Supply Portion 5

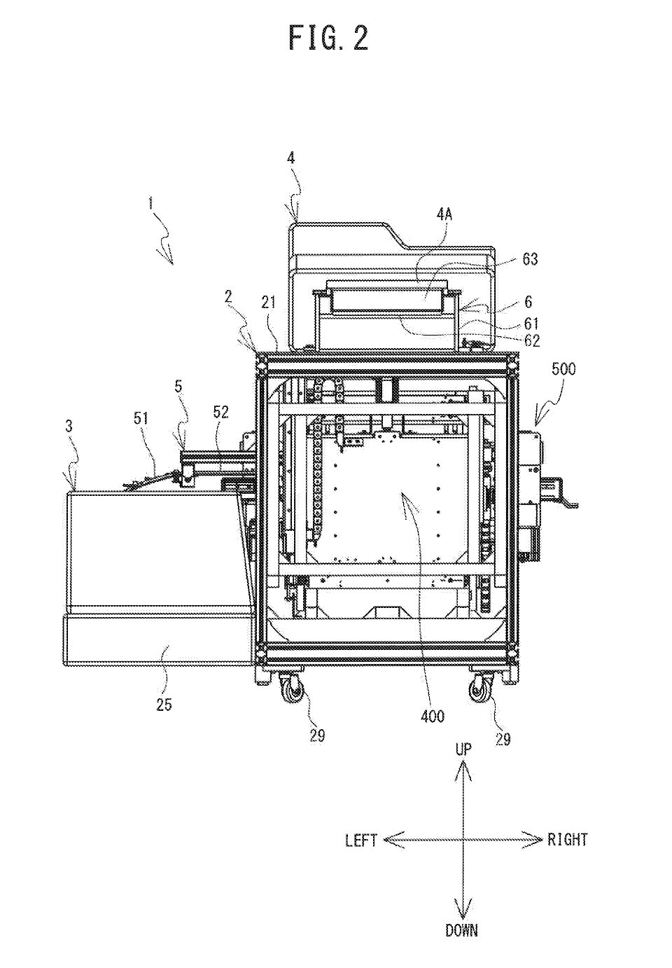

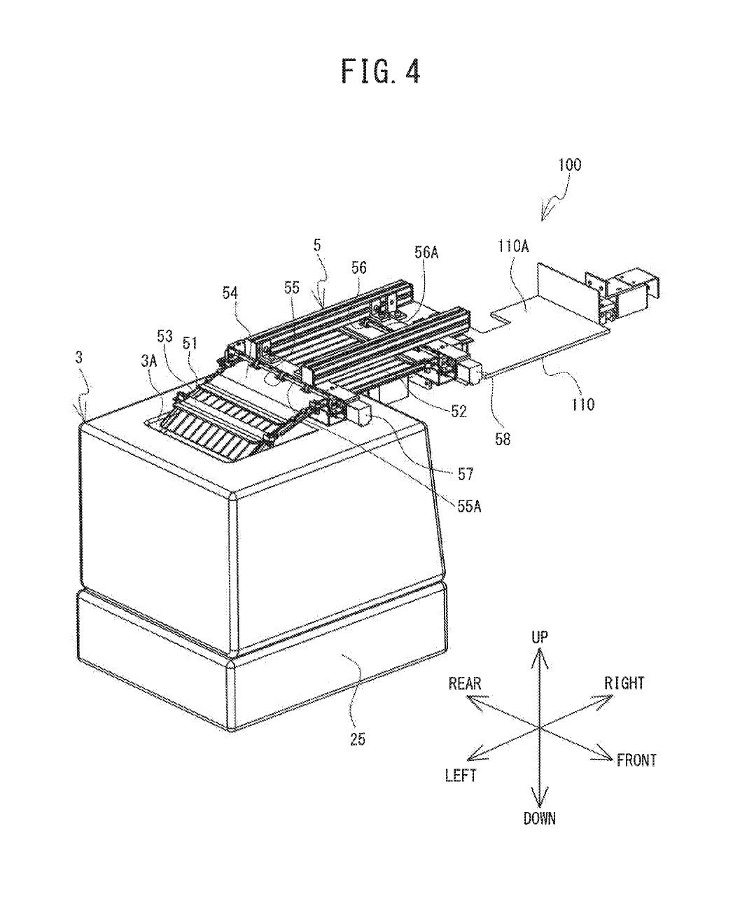

As shown in FIG. 2 and FIG. 4, the paper sheet supply portion 5 includes path plates 51 and 52, guide covers 53 and 54, a plurality of conveyance rollers 55 and 56, and drive motors 57 and 58. The path plate 51 is a plate-like body which extends from the paper sheet discharge opening 3A to the upper right direction, and which extends to a right edge portion of the top surface of the first printer 3. Each of the guide covers 53 and 54 is a plate-like body which is provided above the path plate 51 and which extends in the front-rear direction. A clearance, through which the paper sheets 8A can pass, is formed between the path plate 51 and each of the guide covers 53 and 54.

The path plate 52 is a plate-like body that extends in the left-right direction between the upper right end of the path plate 51 and the paper alignment unit 100. The plurality of conveyance rollers 55 are rotating bodies which are provided on the left end of the path plate 52 and which are aligned in the front-rear direction. The drive motor 57 drives the plurality of conveyance rollers 55 to rotate around a shaft 55A that extends in the front-rear direction. The plurality of conveyance rollers 56 are rotating bodies which are provided on the right end of the path plate 52 and which are aligned in the front-rear direction. The drive motor 58 drives the plurality of conveyance rollers 56 to rotate around a shaft 56A that extends in the front-rear direction.

The paper sheets 8A printed by the first printer 3 are discharged from the paper sheet discharge opening 3A onto the top surface of the path plate 51. The discharged paper sheets 8A move in the upper right direction via the clearance between the path plate 51 and each of the guide covers 53 and 54. The moved paper sheets 8A are conveyed in the right direction along the top surface of the path plate 52 by the conveyance rollers 55 that are driven to rotate by the drive motor 57. The conveyed paper sheets 8A are supplied to the paper alignment unit 100, which will be described later, by the conveyance rollers 56 that are driven to rotate by the drive motor 58.

### 3. Detailed Structure of Cover Sheet Supply Portion 6

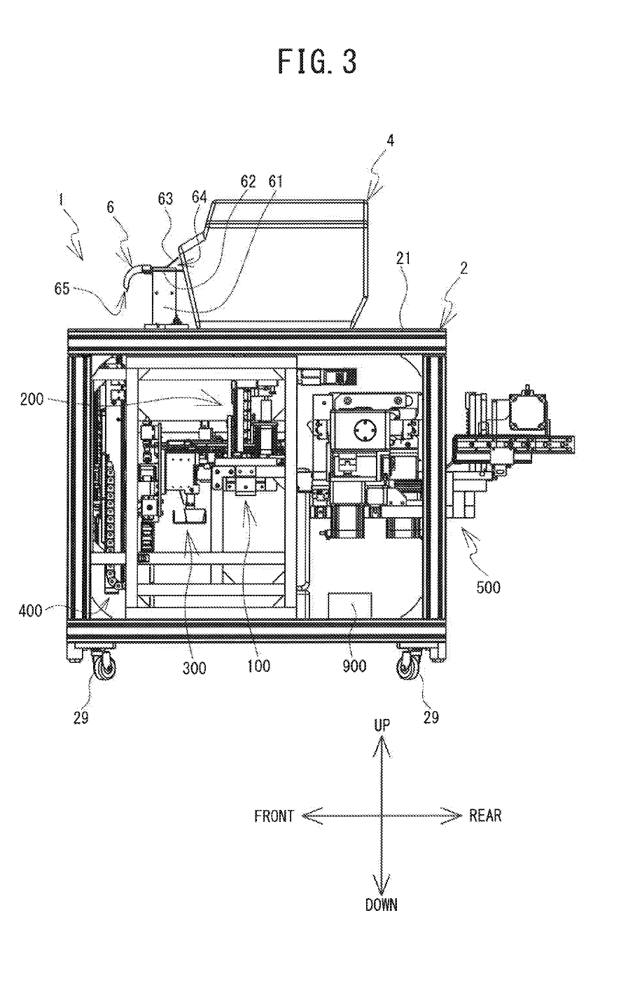

As shown in FIG. 1 and FIG. 3, the cover sheet supply portion 6 includes a support stand 61, a lower guide plate 62 and an upper guide plate 63. The support stand 61 supports the upper guide plate 63 and the lower guide plate 62 above the top plate 21. Each of the lower guide plate 62 and the upper guide plate 63 is a plate-like body which bends in an arc shape to the lower front side in a side view and which extends in the left-right direction. The upper guide plate 63 is provided above the lower guide plate 62. A clearance, through which the cover sheet 9 can pass, is formed between the upper guide plate 63 and the lower guide plate 62.

A clearance that is formed between the rear end of the lower guide plate 62 and the rear end of the upper guide plate 63 is a path inlet 64. The path inlet 64 opens rearward and faces the cover sheet discharge opening 4A (refer to FIG. 2) in the front-rear direction. A clearance that is formed between the front end of the lower guide plate 62 and the front end of the upper guide plate 63 is a path outlet 65. The path outlet 65 opens downward and faces the cover sheet supply opening 22 in the up-down direction. The cover sheet 9 printed by the second printer 4 enters the path inlet 64 from the cover sheet discharge opening 4A, and moves to the lower front side. After that, the printed cover sheet 9 is discharged from the path outlet 65 toward the cover sheet supply opening 22. The cover sheet 9 discharged from the path outlet 65 is supplied to the cover sheet holding unit 400 that will be described later.

### 4. Detailed Structure of Paper Alignment Unit 100

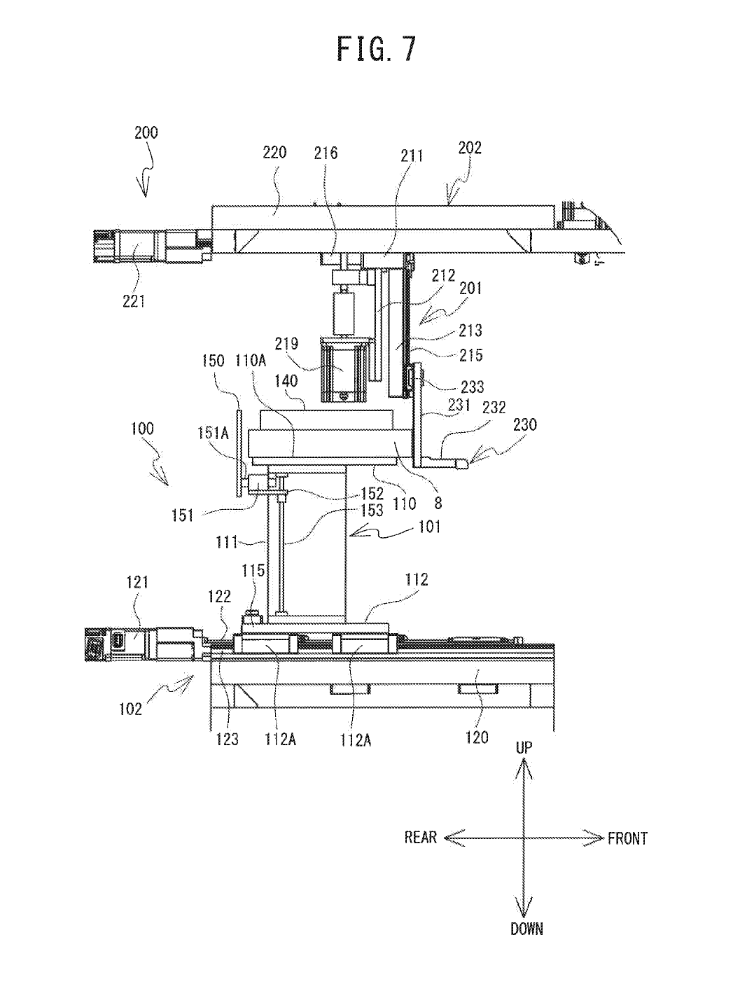

The structure of the paper alignment unit 100 will be explained in detail with reference to FIG. 5 to FIG. 7. FIG. 5 shows almost the whole of the paper alignment unit 100, a part of the bundle operation unit 200, and almost the whole of the gluing unit 300. A rear alignment plate 150 is omitted in FIG. 5. FIG. 6 and FIG. 7 each schematically show an internal structure of a movable portion 101. In FIG. 5 to FIG. 7, a table 110 is in a first conveyance position (which will be described later), a left alignment plate 130 and a right alignment plate 140 are in a separated position (which will be described later), and the rear alignment plate 150 is in a raised position (which will be described later) and the separated position. FIG. 5 shows the bundle of paper sheets 8 using virtual lines.

As shown in FIG. 5, the paper alignment unit 100 includes the movable portion 101, a conveyance portion 102, a left-side paper alignment portion 103 and a right-side paper alignment portion 104. The movable portion 101 can move in the front-rear direction inside the main body frame 2. The conveyance portion 102 causes the movable portion 101 to move in the front-rear direction. The left-side paper alignment portion 103 performs paper alignment of the left end face of the bundle of paper sheets 8 placed on a placement surface 110A. The right-side paper alignment portion 104 performs paper alignment of the right end face of the bundle of paper sheets 8 placed on the placement surface 110A. The left end face and the right end face of the bundle of paper sheets 8 are, respectively, a left-side bundle end face and a right-side bundle end face of the bundle of paper sheets 8.

The conveyance portion 102 includes a base portion 120, a conveyance motor 121, a screw shaft 122 and guide rails 123 and 124. The base portion 120 is a plate-like body that extends in the front-rear direction and the left-right direction, and has a rectangular shape whose long side extends in the front-rear direction. The base portion 120 is coupled and fixed to the main body frame 2 in a state in which it is arranged substantially at the center of the inside of the main body frame 2. The conveyance motor 121 is provided on the rear end of the base portion 120. The screw shaft 122 is provided substantially at the center, in the left-right direction, of the top surface of the base portion 120, and extends forward from the conveyance motor 121. The conveyance motor 121 can rotate the screw shaft 122 around the axis center. The guide rails 123 and 124 are respectively provided on the left side and the right side of the screw shaft 122, on the top surface of the base portion 120, and extend in the front-rear direction such that they are arranged side by side with the screw shaft 122.

The movable portion 101 includes the table 110, a support stand 111, support plates 112 and 113, a nut 114 and a coupling plate 115. The table 110 is a plate-like body having a substantially square shape in a plan view, and includes the placement surface 110A and a slit 110B. The placement surface 110A is the top surface of the table 110 that extends in the horizontal direction, and has a pair of left and right sides and a pair of front and rear sides in a plan view. The plurality of paper sheets 8A can be stacked in the up-down direction on the placement surface 110A. The length in the front-rear direction and the length in the left-right direction of the placement surface 110A are respectively slightly smaller than the length in the front-rear direction and the length in the left-right direction of the paper sheets 8A that are printed by the first printer 3. That is, the placement surface 110A is somewhat smaller than the paper sheets 8A that are printed by the first printer 3. The slit 110B is a portion that is cut out toward the front side from substantially the center, in the left-right direction, of the rear end of the table 110.

The table 110 is provided on the upper end of the support stand 111. The support stand 111 has a cuboid shape inside which a space is formed. The support stand 111 is provided on the support plates 112 and 113. The support plates 112 and 113 are plate-like bodies that are respectively provided to the left of the lower end of the support stand 111 and to the right of the lower end of the support stand 111. A plurality of sliding portions 112A are provided on the lower surface of the support plate 112 such that they are aligned in the front-rear direction. Each of the sliding portions 112A is a sliding member that can move along the guide rail 123. A plurality of sliding portions 113A are fixed to the lower surface of the support plate 113 such that they are aligned in the front-rear direction. Each of the sliding portions 113A is a sliding member that can move along the guide rail 124.

The nut 114 is provided between the support plates 112 and 113, and the screw shaft 122 is inserted through the inside of the nut 114. The nut 114 encapsulates a ball (not shown in the drawings) that rolls between the nut 114 and the screw shaft 122. The nut 114 and the support plates 112 and 113 are coupled and fixed by the coupling plate 115 that extends in the left-right direction. The nut 114 and the screw shaft 122 are a known ball screw (which also applies to another nut and another screw shaft that will be described later).

The table 110 can move in the front-rear direction inside the main body frame 2, in a substantially central position of the main body frame 2 in the left-right direction and the up-down direction. A movable range of the table 110 includes the first conveyance position that is located slightly in front of the substantially central position of the main body frame 2 in the front-rear direction. The first conveyance position is a position of the table 110 in the front-rear direction (refer to FIG. 4 and FIG. 6) where the placement surface 110A is located below and to the right of the path plate 52. When the table 110 is in the first conveyance position, the printed paper sheets 8A that are conveyed by the conveyance rollers 56 are discharged onto the placement surface 110A. At this time, the long sides and the short sides of each of the paper sheets 8A discharged onto the placement surface 110A are respectively parallel to the left-right direction and the front-rear direction. In other words, the first conveyance position is a position of the table 110 in the front-rear direction where the plurality of paper sheets 8A are supplied onto the placement surface 110A.

As shown in FIG. 5 and FIG. 6, the left-side paper alignment portion 103 includes the left alignment plate 130, a solenoid 131 and a support portion 132. The support portion 132 is coupled and fixed to the main body frame 2 in a state in which the support portion 132 is arranged to the left of the movable portion 101. The support portion 132 is a pillar-shaped member which extends in the up-down direction and whose upper end extends in the front-rear direction. The solenoid 131 is supported by the upper end of the support portion 132. The solenoid 131 has a shaft 131A that extends to the right.

The left alignment plate 130 is coupled to the leading end of the shaft 131A. The left alignment plate 130 is a plate-like body which extends in the up-down direction and the front-rear direction and which has a rectangular shape whose long side extends in the front-rear direction. The right surface of the left alignment plate 130 is a surface portion that extends further in the up-down direction than the bundle of paper sheets 8 on the placement surface 110A. In other words, the lower end of the right surface of the left alignment plate 130 is located lower than the bundle of paper sheets 8 on the placement surface 110A. The upper end of the right surface of the left alignment plate 130 is located higher than the bundle of paper sheets 8 on the placement surface 110A. Since the left alignment plate 130 is provided below the conveyance rollers 56, it does not interfere with the paper sheets 8A that are conveyed by the conveyance rollers 56. When the table 110 is in the first conveyance position, the left alignment plate 130 faces the left end face of the bundle of paper sheets 8 on the placement surface 110A, in the left-right direction.

The right-side paper alignment portion 104 has a similar structure to that of the left-side paper alignment portion 103, and is substantially symmetrical with the left-side paper alignment portion 103. The right-side paper alignment portion 104 includes the right alignment plate 140, a solenoid 141 and a support portion 142. The solenoid 141 has a shaft 141A that extends to the left, and is supported by the upper end of the support portion 142 that is provided to the right of the movable portion 101. The right alignment plate 140 is coupled to the leading end of the shaft 141A, and faces the left alignment plate 130 in the left-right direction. The left surface of the right alignment plate 140 is a surface portion that extends further in the up-down direction than the bundle of paper sheets 8 on the placement surface 110A. When the table 110 is in the first conveyance position, the right alignment plate 140 faces the right end face of the bundle of paper sheets 8 on the placement surface 110A, in the left-right direction.

As shown in FIG. 6 and FIG. 7, the movable portion 101 includes the rear alignment plate 150, a solenoid 151, a support portion 152, a screw shaft 153, a guide rail 154 and a lifting motor 155. The screw shaft 153 and the guide rail 154 are provided hanging across the inside of the support stand 111 in the up-down direction such that they are arranged side by side in the left-right direction. The lifting motor 155 is connected to the lower end of the screw shaft 153. The lifting motor 155 can rotate the screw shaft 153 around the axis center.

The support portion 152 is a plate-like body that extends in the front-rear direction and the left-right direction, and has a rectangular shape whose long side extends in the left-right direction. The screw shaft 153 is inserted through a cylindrical nut 152A that is provided to the left of a front edge portion of the support portion 152. The guide rail 154 is inserted through a cylindrical sliding portion 152B that is provided to the right of the front edge portion of the support portion 152. The solenoid 151 is provided on the top surface of the support portion 152. The solenoid 151 has a shaft 151A that extends rearward. The rear alignment plate 150 is coupled to the leading end of the shaft 151A. The rear alignment plate 150 is a plate-like body that extends in the up-down direction and the left-right direction, and has a rectangular shape whose long side extends in the left-right direction. The front surface of the rear alignment plate 150 is a surface portion that extends in the up-down direction.

With the above-described structure, when the conveyance motor 121 drives and rotates the screw shaft 122, the nut 114 moves in the front-rear direction. In accordance with the movement of the nut 114, the support plates 112 and 113 coupled via the coupling plate 115 move along the guide rails 123 and 124, respectively. The table 110 supported on the support stand 111 moves in the front-rear direction.

When the solenoid 131 retracts the shaft 131A, the left alignment plate 130 is held in a separated position where it is separated leftward from the table 110 in a front view. When the solenoid 131 advances the shaft 131A, the left alignment plate 130 moves rightward from the separated position. When the solenoid 141 retracts the shaft 141A, the right alignment plate 140 is held in a separated position where it is separated rightward from the table 110 in a front view. When the solenoid 141 advances the shaft 141A, the right alignment plate 140 moves leftward from the separated position. When both the left alignment plate 130 and the right alignment plate 140 are located in the separated position, the distance between the left alignment plate 130 and the right alignment plate 140 in the left-right direction is larger than the long side (the length in the left-right direction) of the paper sheet 8A.

When the lifting motor 155 drives and rotates the screw shaft 153, the nut 152A moves in the up-down direction. In accordance with the movement of the nut 152A, the sliding portion 152B moves along the guide rail 154. The rear alignment plate 150 that is supported to the rear of the support portion 152 moves in the up-down direction. The rear alignment plate 150 can move upward to the raised position. When the rear alignment plate 150 is in the raised position, the lower end of the front surface of the rear alignment plate 150 is located lower than the placement surface 110A and the upper end of the front surface of the rear alignment plate 150 is located higher than the bundle of paper sheets 8 on the placement surface 110A. In other words, the front surface of the rear alignment plate 150 located in the raised position extends further in the up-down direction than the bundle of paper sheets 8 on the placement surface 110A. The rear alignment plate 150 can move downward to a lowered position. When the rear alignment plate 150 is located in the lowered position, the whole of the rear alignment plate 150 is located below the placement surface 110A.

When the rear alignment plate 150 is in the raised position, it faces the rear end face of the bundle of paper sheets 8 on the placement surface 110A in the front-rear direction. The rear end face of the bundle of paper sheets 8 is a rear-side bundle end face of the bundle of paper sheets 8. When the solenoid 151 advances the shaft 151A, the rear alignment plate 150 is held in a separated position where it is separated rearward from the table 110 in a side view. When the solenoid 151 retracts the shaft 151A, the rear alignment plate 150 moves forward from the separated position.

### 5. Detailed Structure of Bundle Operation Unit 200

The structure of the bundle operation unit 200 will be explained in detail with reference to FIG. 5 and FIG. 7. In FIG. 5 and FIG. 7, a front alignment plate 231 is in a paper alignment position that will be described later. The bundle operation unit 200 includes a movable portion 201 and a conveyance portion 202. The movable portion 201 is provided inside the main body frame 2 and above the paper alignment unit 100 such that the movable portion 201 can move in the front-rear direction. The conveyance portion 202 causes the movable portion 201 to move in the front-rear direction.

The conveyance portion 202 includes a base portion 220, a conveyance motor 221, and a screw shaft and a guide rail that are not shown in the drawings. The base portion 220 has a rectangular frame structure that extends in the front-rear direction and the left-right direction. The base portion 220 is coupled and fixed to the main body frame 2 in a state in which it is arranged on an upper portion of the inside of the main body frame 2. The conveyance motor 221 is provided on the rear end of the base portion 220. The screw shaft (not shown in the drawings) is provided substantially at the center, in the left-right direction, of the base portion 220, and extends forward from the conveyance motor 221. The conveyance motor 221 can rotate the screw shaft (not shown in the drawings) around the axis center. The guide rail (not shown in the drawings) is provided to the right of the screw shaft (not shown in the drawings), and extends in the front-rear direction such that the guide rail is arranged side by side with the screw shaft (not shown in the drawings).

The movable portion 201 includes a movable body (not shown in the drawings), a support plate 211, coupling plates 212 and 213, a screw shaft 214, a pair of guide rails 215, a belt 216, pulleys 217 and 218, a lifting motor 219 and a bundle operation portion 230. The movable body (not shown in the drawings) is a column-shaped member that extends in the left-right direction. The movable body (not shown in the drawings) includes a nut and a sliding portion that are not shown in the drawings. The nut (not shown in the drawings) is provided on the right end of the movable body (not shown in the drawings), and the screw shaft provided on the base portion 220 is inserted through the nut. The sliding portion (not shown in the drawings) is a sliding member which is provided on the left end of the movable body (not shown in the drawings) and which can move along the guide rail provided on the base portion 220.

The support plate 211 is a plate-like body that extends in the front-rear direction and the left-right direction, and has a rectangular shape whose long side extends in the left-right direction. The support plate 211 is supported below the movable body (not shown in the drawings). The coupling plates 212 and 213 are plate-like bodies that extend downward from the lower surface of the support plate 211. The coupling plate 212 is provided to the rear of the coupling plate 213. The lifting motor 219 is provided on the rear surface of the coupling plate 212. The lifting motor 219 has a shaft 219A that extends upward from the lifting motor 219. The pulley 218 is provided on the leading end of the shaft 219A.

The screw shaft 214 is provided on the front surface of the coupling plate 213, and extends in the up-down direction. The pulley 217 is provided on the upper end of the screw shaft 214. Both of the pulleys 217 and 218 are provided higher than the support plate 211, and face each other in the front-rear direction. The belt 216 is stretched between the pulleys 217 and 218. The pair of guide rails 215 are respectively provided to the left and to the right of the screw shaft 214 on the front surface of the coupling plate 213, and extend in the up-down direction such that they are arranged side by side with the screw shaft 214. Note that the vertical distance between the lifting motor 219 and the table 110 and the vertical distance between the table 110 and the coupling plates 212 and 213 are larger than the vertical length of the bundle of paper sheets 8 on the placement surface 110A.

The bundle operation portion 230 is provided to the front of the coupling plate 213. The bundle operation portion 230 includes the front alignment plate 231, a retaining plate 232, a pair of sliding portions 233 and a nut (not shown in the drawings). The front alignment plate 231 is a plate-like body that extends in the up-down direction and the left-right direction, and has a rectangular shape whose long side extends in the left-right direction. The rear surface of the front alignment plate 231 is a surface portion that extends in the up-down direction. In the present embodiment, the rear surface of the front alignment plate 231 is a surface portion that can come into contact with the entire front end face (which will be described later) of the bundle of paper sheets 8 on the placement surface 110A. The retaining plate 232 is a plate-like body that extends forward from the lower end of the front alignment plate 231, and has a rectangular shape whose long side extends in the left-right direction in a plan view. The lower surface of the retaining plate 232 is a surface portion that extends in the horizontal direction. In the present embodiment, the lower surface of the retaining plate 232 is a surface portion that can come into contact with the top surface of the bundle of paper sheets 8 on the placement surface 110A, across the left-right direction.

The central position of the bundle operation portion 230 in the left-right direction substantially matches the central position of the table 110 in the left-right direction. The pair of sliding portions 233 are respectively provided on the upper left end and the upper right end of the rear surface of the front alignment plate 231. Each of the sliding portions 233 is a sliding member that can move along a corresponding one of the guide rails 215. The nut (not shown in the drawings) is provided at substantially the center, in the left-right direction, of the rear surface of the front alignment plate 231, and the screw shaft 214 is inserted through the nut.

With the above-described structure, when the conveyance motor 221 drives and rotates the screw shaft (not shown in the drawings), the movable body (not shown in the drawings) of the movable portion 201, which is provided with the nut (not shown in the drawings), moves in the front-rear direction along the guide rail (not shown in the drawings). The bundle operation portion 230 supported below the front side of the support plate 211 moves in the front-rear direction above the paper alignment unit 100. A movable range of the bundle operation portion 230 in the front-rear direction includes a first horizontal position, which is slightly in front of the substantially central position of the main body frame 2 in the front-rear direction.

When the lifting motor 219 drives and rotates the shaft 219A, the screw shaft 214 is driven to rotate via the belt 216 and the pulleys 217 and 218. The bundle operation portion 230 provided with the nut (not shown in the drawings) moves in the up-down direction along the guide rails 215. The bundle operation portion 230 can move downward to a first vertical position. When the bundle operation portion 230 is in the first vertical position, the lower end of the rear surface of the front alignment plate 231 is located lower than the placement surface 110A, and the upper end of the rear surface of the front alignment plate 231 is located higher than the bundle of paper sheets 8 on the placement surface 110A. In other words, the rear surface of the front alignment plate 231 in the first vertical position extends further in the up-down direction than the bundle of paper sheets 8 on the placement surface 110A. The bundle operation portion 230 can move upward to a second vertical position. When the bundle operation portion 230 is in the second vertical position, the whole bundle operation portion 230 is located higher than the bundle of paper sheets 8 on the placement surface 110A.

When the bundle operation portion 230 is in the first horizontal position and the first vertical position, the front alignment plate 231 is arranged slightly in front of the table 110 in the first conveyance position. At this time, the front alignment plate 231 is in a position (the paper alignment position) where it faces the front end face of the bundle of paper sheets 8 on the placement surface 110A, in the front-rear direction. The front end face of the bundle of paper sheets 8 is a front-side bundle end face of the bundle of paper sheets 8. When the front alignment plate 231 is in the paper alignment position and the rear alignment plate 150 is in the raised position, the front alignment plate 231 and the rear alignment plate 150 face each other in the front-rear direction. The distance, in the front-rear direction, between the front alignment plate 231 in the paper alignment position and the rear alignment plate 150 in the separated position is larger than the short side (the length in the front-rear direction) of the paper sheet 8A.

### 6. Detailed Structure of Gluing Unit 300

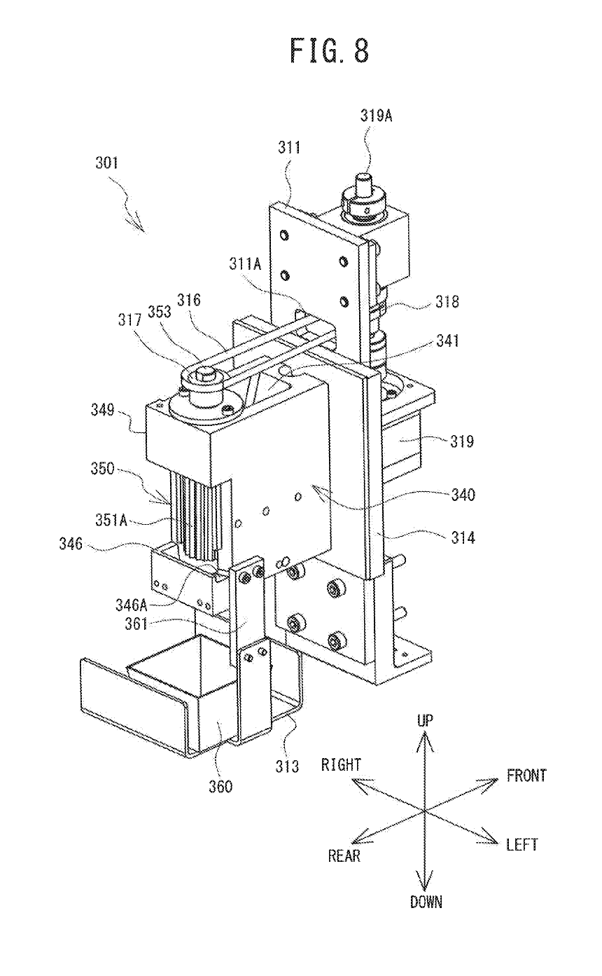

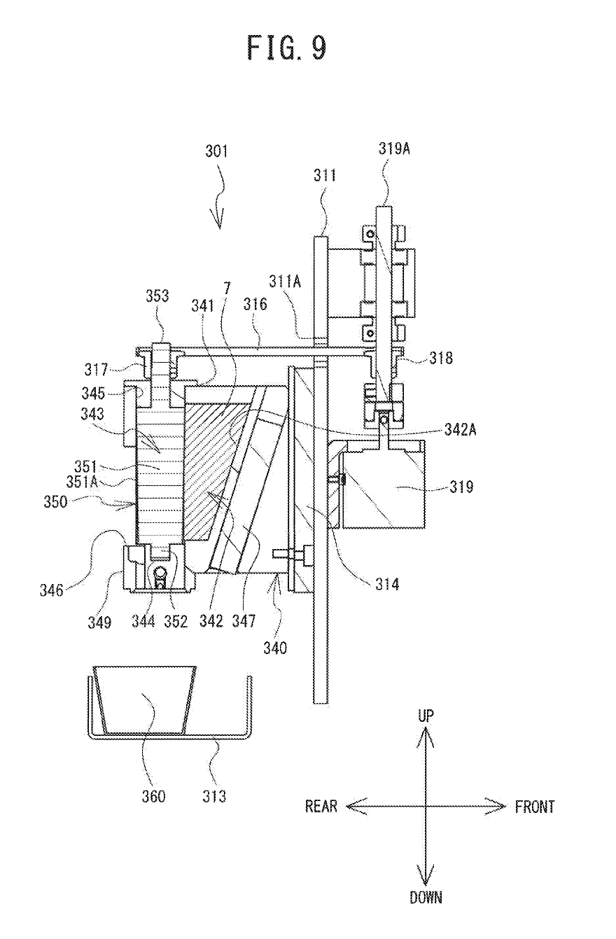

The gluing unit 300 will be explained in detail with reference to FIG. 5, FIG. 8 and FIG. 9. FIG. 9 is a cross-sectional view when a cross section which passes through substantially the center, in the left-right direction, of a movable portion 301 and which extends in the front-rear direction and the up-down direction is seen from the left side. In FIG. 5, a glue applying portion 340 is in a retracted position that will be described later. As shown in FIG. 5, the gluing unit 300 is arranged in front of the table 110 in the first conveyance position. The gluing unit 300 includes the movable portion 301 and a conveyance portion 302. The movable portion 301 can move in the left-right direction inside the main body frame 2 and in front of the table 110 in the first conveyance position. The conveyance portion 302 causes the movable portion 301 to move in the left-right direction.

The conveyance portion 302 includes a base portion 320, a conveyance motor 321 and a screw shaft 322. The base portion 320 is a column-shaped member that intersects the base portion 120 in a plan view and extends in the left-right direction. The base portion 320 is coupled and fixed to the main body frame 2 in a state in which it is arranged above the front end of the base portion 120. The conveyance motor 321 is provided on the left end of the base portion 320. The screw shaft 322 is provided on the rear surface of the base portion 320, and extends to the right from the conveyance motor 321. The conveyance motor 321 can rotate the screw shaft 322 around the axis center.

As shown in FIG. 8 and FIG. 9, the movable portion 301 includes a support portion 311, a nut 312 (refer to FIG. 5), a glue receiving member mounting portion 313, a heat-resistant plate 314, a chain 316, pulleys 317 and 318, a drive motor 319 and the glue applying portion 340. The support portion 311 is a plate-like body that extends in the up-down direction and the left-right direction, and has a rectangular shape whose long side extends in the up-down direction. The nut 312 is provided on the lower end of the front surface of the support portion 311, and the screw shaft 322 is inserted through the nut 312. The drive motor 319 is provided on the front surface of the support portion 311 and above the nut 312. The drive motor 319 has a shaft 319A that extends upward from the drive motor 319. The pulley 318 is provided on the shaft 319A.

The heat-resistant plate 314 is provided on the rear surface of the support portion 311. The glue applying portion 340 is provided on the rear surface of the heat-resistant plate 314. The glue applying portion 340 is a movable body that applies a glue 7 within a glue application area (which will be described later) while moving in the left-right direction across at least the length of the bundle of paper sheets 8 in the left-right direction. The glue applying portion 340 includes a main body portion 349 and a glue applying roller 350.

The glue applying roller 350 has a substantially cylindrical shape that extends in the up-down direction, and can apply the liquid glue 7 onto a target object. The glue applying roller 350 includes a roller main body 351, a lower shaft 352 and an upper shaft 353. The roller main body 351 is a cylindrical-shaped body that has a peripheral surface 351A to which the glue 7 can attach. The peripheral surface 351A includes a plurality of crest portions and a plurality of trough portions which extend in the up-down direction and which are continuously and alternately formed in the peripheral direction. The lower shaft 352 is a shaft with a small diameter that protrudes downward from the center of the lower end face of the roller main body 351. The upper shaft 353 is a shaft with a small diameter that protrudes upward from the center of the upper end face of the roller main body 351.

The main body portion 349 is a housing having a substantially cuboid shape whose long side extends in the up-down direction, and can house the glue applying roller 350 and the glue 7 inside the main body portion 349. The main body portion 349 includes a glue injection port 341, a glue storage portion 342, a roller mounting portion 343, shaft receiving portions 344 and 345, a glue application opening 346 and a heater 347. The glue injection port 341 is an opening which is provided in the top surface of the main body portion 349 and from which the glue 7 can be injected. The glue storage portion 342 is a space which is provided inside the main body portion 349 and which has substantially a bottomed box shape that extends downward from the glue injection port 341. The glue storage portion 342 stores the glue 7 injected from the glue injection port 341.

The roller mounting portion 343 is a space which is provided inside the main body portion 349 and which is communicatively connected from a lower side part of the glue storage portion 342 to the rear. The roller mounting portion 343 of the present embodiment is communicatively connected to the glue storage portion 342 in the front-rear direction, across substantially the whole of the glue storage portion 342 in the up-down direction. The shaft receiving portion 344 is a recessed portion that extends downward from the center of the lower end of the roller mounting portion 343. The shaft receiving portion 345 is an opening which is provided in the top surface of the main body portion 349 and to the rear of the glue injection port 341, and which is communicatively connected to the roller mounting portion 343 in the up-down direction.

The glue application opening 346 is an opening which is cut out from the rear surface of the main body portion 349 to the front, and which is communicatively connected to the roller mounting portion 343 in the front-rear direction. The glue application opening 346 extends further in the up-down direction than the lower side part of the glue storage portion 342. The glue application opening 346 of the present embodiment is formed from a position in the up-down direction that is substantially the same as that of the lower end of the glue storage portion 342, to a position that is slightly higher than substantially the center of the glue storage portion 342 in the up-down direction. The glue application opening 346 exposes the peripheral surface 351A of the glue applying roller 350 to the rear from the inside of the roller mounting portion 343. A recessed portion that is recessed downward in the lower left end of the glue application opening 346 is a glue guide portion 346A. The glue guide portion 346A guides the glue 7 that drips along the peripheral surface 351A of the glue applying roller 350, toward a glue receiving member 360 that will be described later. The heater 347 is a heating element that is arranged inside the main body portion 349 and in front of the glue storage portion 342.

The roller main body 351 is housed in the roller mounting portion 343 in a state in which the lower shaft 352 is inserted in the shaft receiving portion 344 and the upper shaft 353 is inserted in the shaft receiving portion 345. The roller main body 351 can rotate inside the roller mounting portion 343 around the lower shaft 352 that is axially supported by the shaft receiving portion 344 and around the upper shaft 353 that is axially supported by the shaft receiving portion 345. A part of the peripheral surface 351A is exposed to the rear of the main body portion 349 via the glue application opening 346. The part of the peripheral surface 351A that is exposed from the glue application opening 346 is referred to as a glue application surface of the glue applying roller 350. The glue application surface of the glue applying roller 350 is located in a front-rear direction position that is substantially the same as the rear surface of the front alignment plate 231 located in the paper alignment position. The glue application surface of the glue applying roller 350 extends further in the up-down direction than the bundle of paper sheets 8 on the placement surface 110A.

The upper shaft 353 penetrates the shaft receiving portion 345 and extends to above the main body portion 349. The pulley 317 is provided on the leading end of the upper shaft 353. The pulleys 317 and 318 face each other in the front-rear direction. The chain 316 is stretched between the pulleys 317 and 318 via a through hole 311A that is formed in the support portion 311. The glue receiving member mounting portion 313 is provided below the glue applying portion 340. The glue receiving member mounting portion 313 has a surface on which the glue receiving member 360 can be placed. The glue receiving member mounting portion 313 is coupled and fixed to the main body portion 349 via a coupling plate 361. For example, the glue receiving member 360 is a cup which opens upward such that it can accumulate liquid.

With the above-described structure, when the conveyance motor 321 drives and rotates the screw shaft 322, the support portion 311 provided with the nut 312 moves in the left-right direction. The glue applying portion 340 that is supported to the rear of the support portion 311 moves in the left-right direction in front of the table 110 located in the first conveyance position. The right end of a movable range of the glue applying portion 340 is the retracted position. When the glue applying portion 340 is in the retracted position, the glue applying portion 340 is separated rightward from the movable range of the table 110 (namely, an area through which the table 110 that moves in the front-rear direction can pass).

When the glue applying portion 340 moves to the left from the retracted position, the glue applying portion 340 enters the movable range of the table 110. The glue applying portion 340 can move in the left-right direction within the movable range of the table 110. A trajectory in which the glue application surface of the glue applying roller 350 moves along with the movement of the glue applying portion 340 is referred to as the glue application area of the glue applying portion 340. The glue application area of the glue applying portion 340 extends in the left-right direction across the movable range of the table 110.

The roller mounting portion 343 has substantially the same shape and size as the roller main body 351. Therefore, a clearance formed between the peripheral surface 351A and an inner wall of the roller mounting portion 343 is narrow. The glue 7 injected from the glue injection port 341 is unlikely to flow out from the glue storage portion 342 to the roller mounting portion 343, and is therefore stored in the glue storage portion 342. Since the glue 7 stored in the glue storage portion 342 is heated by the heater 347, solidification of the glue 7 in the glue storage portion 342 is suppressed. The heat-resistant plate 314 blocks off the heat generated from the heater 347, to the rear of the drive motor 319. Thus, a rotation failure of the drive motor 319 caused by the heat generated from the heater 347 is suppressed.

When the drive motor 319 drives and rotates the shaft 319A, the glue applying roller 350 is driven to rotate around an axis extending in the up-down direction, via the chain 316 and the pulleys 317 and 318. At this time, a part of the glue 7 stored in the glue storage portion 342 moves to the glue application opening 346 in a state in which it is held by the trough portions of the peripheral surface 351A. The glue 7 is supplied to the glue application surface of the glue applying roller 350, and the supplied glue 7 is applied to the target object that comes into contact with the glue application surface. The glue 7 that drips along the peripheral surface 351A without being applied to the target object is discharged downward via the glue guide portion 346A. Then, the glue 7 drops into the glue receiving member 360 and is accumulated.

A front wall 342A of the inner walls of the glue storage portion 342 is inclined downward and rearward. The cross-sectional area of the glue storage portion 342 in the horizontal direction gradually decreases downward. The glue 7 stored in the glue storage portion 342 moves downward and rearward along the front wall 342A due to its own weight. Therefore, the glue 7 is likely to be supplied from the lower side part of the glue storage portion 342 to a lower side part of the peripheral surface 351A. The lower side part of the peripheral surface 351A (namely, the glue application surface of the glue applying roller 350) is a part that is exposed to the glue application opening 346 as a result of the rotation of the glue applying roller 350. Therefore, a sufficient amount of the glue 7 is stably supplied to the glue application surface of the glue applying roller 350.

### 7. Detailed Structure of Cover Sheet Holding Unit 400

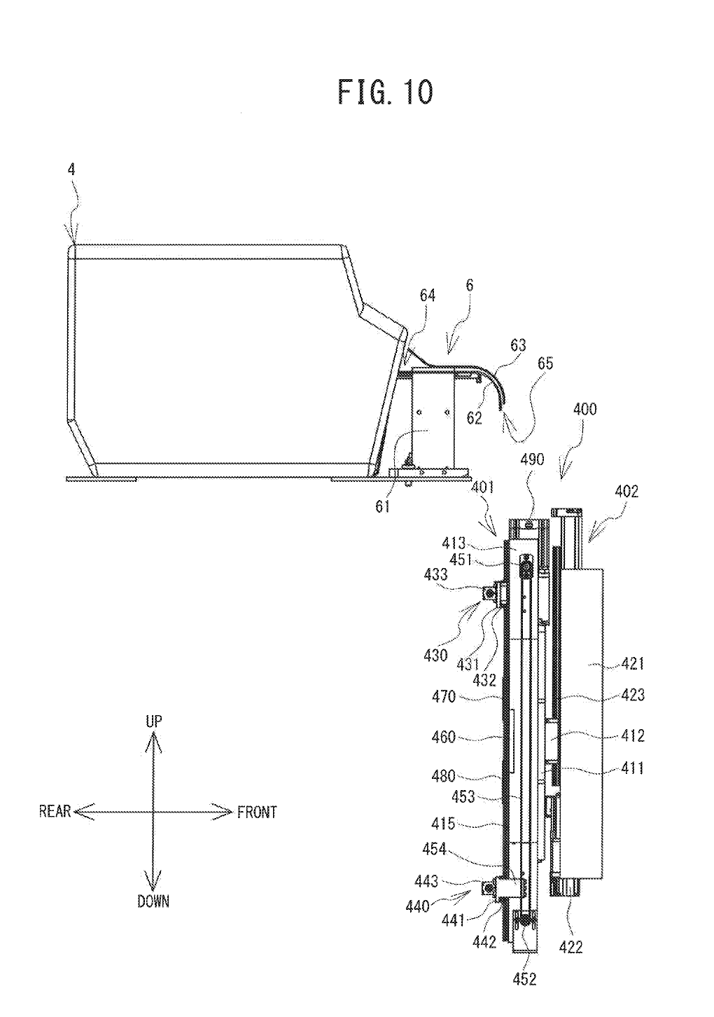

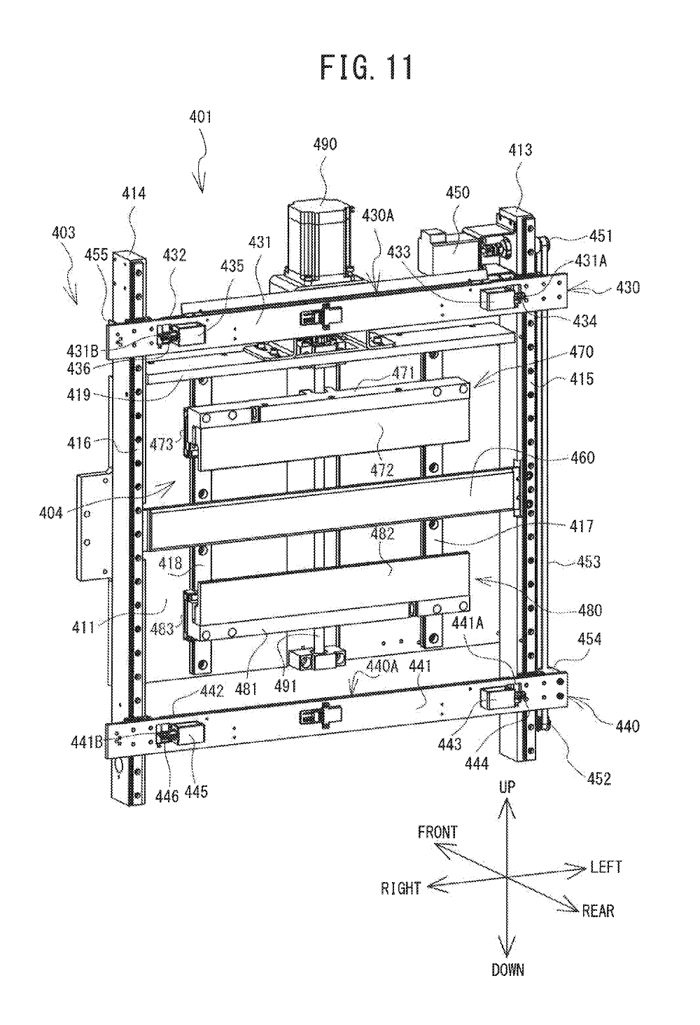

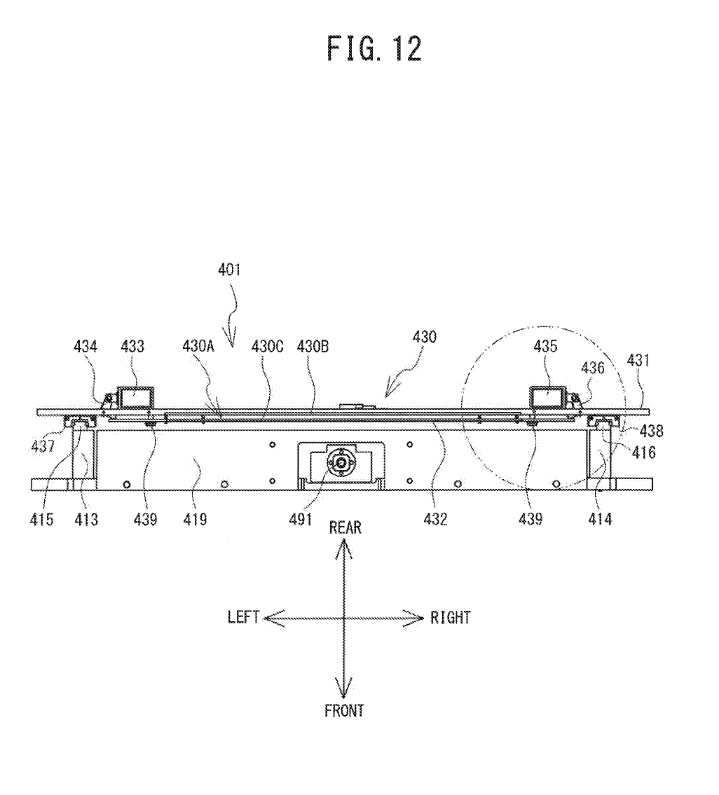

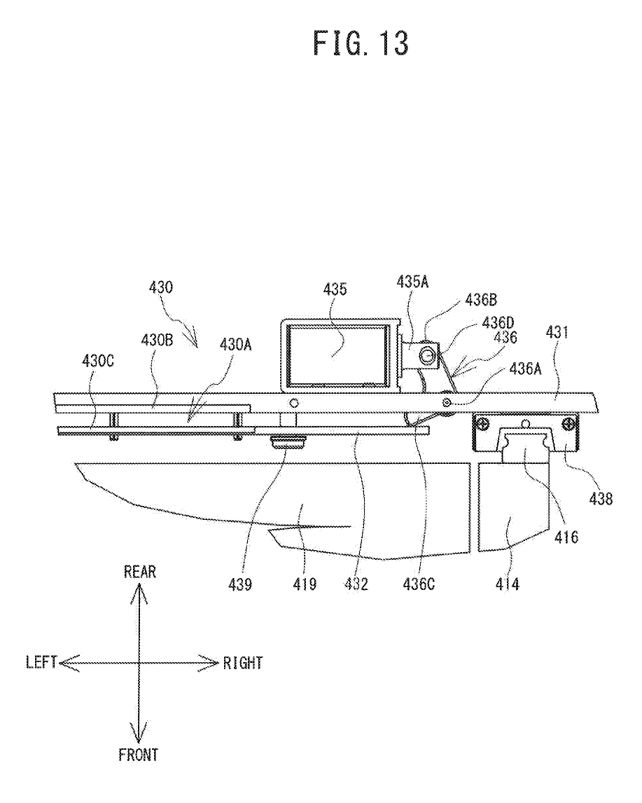

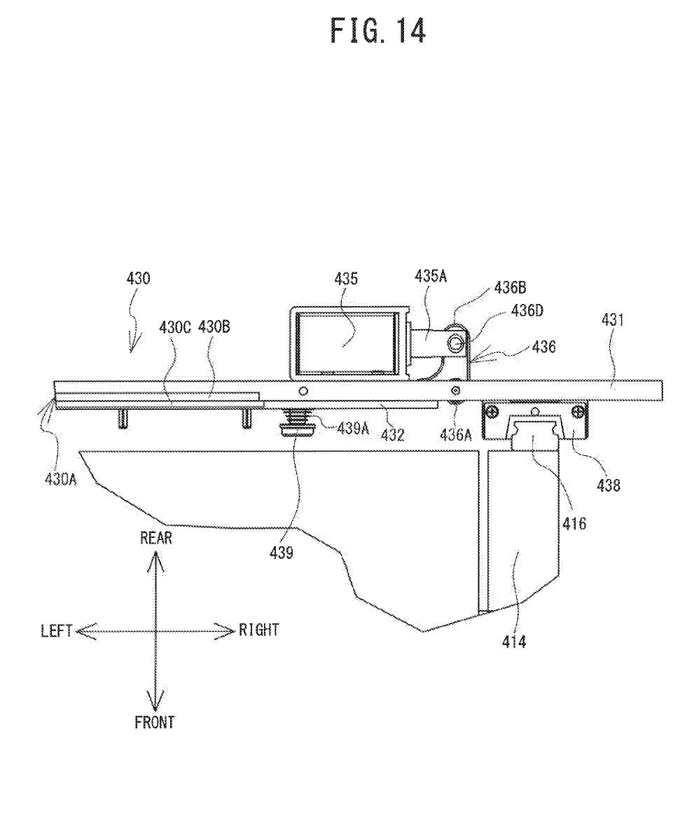

The structure of the cover sheet holding unit 400 will be explained in detail with reference to FIG. 10 to FIG. 14. A lifting motor 490 and a positioning plate 455 are omitted in FIG. 12. In FIG. 13 and FIG. 14, a range surrounded by a virtual line in FIG. 12 is enlarged. In FIG. 10, a movable portion 401 is in a reference position that will be described later. In FIG. 10 and FIG. 11, an upper clamp 430 and a lower clamp 440 are respectively located in an upper reference position and a lower reference position that will be described later. In FIG. 10 and FIG. 11, an upper clamp 470 is located at the upper end of its movable range and a lower clamp 480 is located at the lower end of its movable range. In FIG. 12 and FIG. 13, an operation area 430A is opened. In FIG. 14, the operation area 430A is closed.

As shown in FIG. 10, the cover sheet holding unit 400 is arranged to the front of the table 110 in the first conveyance position and the gluing unit 300. The cover sheet holding unit 400 includes the movable portion 401 and a conveyance portion 402. The movable portion 401 can move in the up-down direction inside the main body frame 2 and in front of the glue applying portion 340. The conveyance portion 402 causes the movable portion 401 to move in the up-down direction.

The conveyance portion 402 includes a base portion 421, a conveyance motor 422, a pair of guide rails 423 and a screw shaft (not shown in the drawings). The base portion 421 has a rectangular frame structure that extends in the front-rear direction and the left-right direction. The base portion 421 is coupled and fixed to the main body frame 2 in a state in which it is arranged on the front end of the main body frame 2. The conveyance motor 422 is provided on the lower end of the base portion 421. The screw shaft (not shown in the drawings) is arranged substantially at the center, in the left-right direction, of the base portion 421, and extends upward from the conveyance motor 422. The conveyance motor 422 can rotate the screw shaft (not shown in the drawings) around the axis center. The pair of guide rails 423 are respectively arranged to the left and to the right of the screw shaft (not shown in the drawings) on the base portion 421, and extend in the up-down direction such that the guide rails 423 are arranged side by side with the screw shaft (not shown in the drawings).

As shown in FIG. 10 and FIG. 11, the movable portion 401 is arranged to the rear of the conveyance portion 402 and within a range of the cover sheet supply opening 22 (refer to FIG. 1) in a plan view. The movable portion 401 includes a support plate 411, a pair of sliding portions 412, a nut (not shown in the drawings), support frames 413 and 414, rear rails 415 and 416, front rails 417 and 418, and a coupling frame 419. The support plate 411 is a plate-like body having a substantially square shape in a front view. The pair of sliding portions 412 are respectively provided on the left end and the right end of the front surface of the support plate 411. Each of the sliding portions 412 is a sliding member that can move along a corresponding one of the guide rails 423. The nut (not shown in the drawings) is provided substantially in the central portion of the front surface of the support plate 411, and the screw shaft (not shown in the drawings) of the conveyance portion 402 is inserted through the nut.

The support frames 413 and 414 are respectively provided on the left end and the right end of the rear surface of the support plate 411. The support frames 413 and 414 are arranged to face each other in the left-right direction, and are column-shaped bodies that extend in the up-down direction. The rear rails 415 and 416 are respectively provided on the rear surfaces of the support frames 413 and 414. The rear rails 415 and 416 pass through a contact position that will be described later, and extend in the up-down direction such that they are parallel to each other. The length of the rear rails 415 and 416 is equal to or larger than the length of the cover sheet 9 in the up-down direction. The rear rails 415 and 416 extend higher than the upper end of the support plate 411, and extend lower than the lower end of the support plate 411. The rear rails 415 and 416 can guide the upper clamp 430 and the lower clamp 440, which will be described later, in the up-down direction.

The front rails 417 and 418 are provided on the rear surface of the support plate 411 and between the support frames 413 and 414. The front rails 417 and 418 are respectively arranged to the right of the support frame 413 and to the left of the support frame 414, and extend in the up-down direction such that they are parallel to each other. The front rails 417 and 418 extend from the upper end to the lower end of the support plate 411. The front rails 417 and 418 can guide the upper clamp 470 and the lower clamp 480, which will be described later, in the up-down direction. The coupling frame 419 is a plate-like body that extends rearward from the upper end of the support plate 411, and has a rectangular shape whose long side extends in the left-right direction in a plan view.

As shown in FIG. 11 and FIG. 12, the movable portion 401 includes a first clamp 403 that can clamp the cover sheet 9, from the front and rear sides, that is supplied to the cover sheet holding unit 400. The first clamp 403 includes the upper clamp 430 and the lower clamp 440. The upper clamp 430 and the lower clamp 440 are aligned in the up-down direction, and selectively clamp and release the cover sheet 9 in different positions in the up-down direction.

The upper clamp 430 includes a rear plate 431, a front plate 432, a left solenoid 433, an open/close link 434, a right solenoid 435, an open/close link 436, sliding portions 437 and 438, and a pair of coupling shafts 439. The rear plate 431 is a plate-like body that extends in the up-down direction and the left-right direction, and has a rectangular shape whose long side extends in the left-right direction. The rear plate 431 is arranged to the rear of the support frames 413 and 414. The sliding portions 437 and 438 are respectively provided on the left end and the right end of the front surface of the rear plate 431. The sliding portion 437 can move along the rear rail 415. The sliding portion 438 can move along the rear rail 416.

The rear plate 431 has a through hole 431A that is formed to the right of the sliding portion 437, and a through hole 431B that is formed to the left of the sliding portion 438. The through holes 431A and 431B penetrate the rear plate 431 in the front-rear direction. The left solenoid 433 is provided on the rear surface of the rear plate 431 and to the right of the through hole 431A. The open/close link 434 is a plate-like body which is arranged in the through hole 431A and which has a substantially L-shape in a plan view. The right solenoid 435 is provided on the rear surface of the rear plate 431 and to the left of the through hole 431B. The open/close link 436 is a plate-like body which is arranged in the through hole 431B and which has a substantially L-shape in a plan view.

The front plate 432 is a plate-like body which is arranged to the front of the rear plate 431 and which extends substantially parallel to the rear plate 431. The left end and the right end of the front plate 432 respectively face the through holes 431A and 431B in the front-rear direction. The pair of coupling shafts 439 are shafts which are respectively arranged to the right of the through hole 431A and to the left of the through hole 431B, and which protrude forward from the front surface of the rear plate 431. The pair of coupling shafts 439 penetrate the front plate 432 in the front-rear direction, and support the front plate 432 such that the front plate 432 can move in the front-rear direction. A clearance between the rear plate 431 and the front plate 432 that face each other in the front-rear direction is the operation area 430A.

The rear plate 431 and the front plate 432 have guide surfaces 430B and 430C, respectively. The guide surface 430B is a surface that is inclined forward and downward from the top surface of the rear plate 431, across a range facing the operation area 430A in the left-right direction. The guide surface 430C is a surface that is inclined rearward and downward from the top surface of the front plate 432, across a range facing the operation area 430A in the left-right direction. That is, the upper end of the operation area 430A where the guide surfaces 430B and 430C are formed has an opening width in the front-rear direction that is largest in the operation area 430A.

As shown in FIG. 13, the right solenoid 435 has a shaft 435A that extends to the right. When the right solenoid 435 is turned on, the shaft 435A is retracted, and when the right solenoid 435 is turned off, the shaft 435A advances. The open/close link 436 is supported inside the through hole 431B (refer to FIG. 11) via a shaft 436A that extends in the up-down direction. The open/close link 436 can swing around the shaft 436A inside the through hole 431B. A cylindrical-shaped coupling shaft 436D extends upward from an end 436B that is the rear end of the open/close link 436. The coupling shaft 436D is coupled to the shaft 435A. An end 436C that is the front end of the open/close link 436 is in contact with the right end of the rear surface of the front plate 432. Each of the coupling shafts 439 has a coil spring 439A (refer to FIG. 14) that urges the front plate 432 rearward.

Although not shown in the drawings, the left solenoid 433 has a shaft that extends to the left, similarly to the right solenoid 435. The open/close link 434 is swingably supported inside the through hole 431A, similarly to the open/close link 436. The rear side end of the open/close link 434 is coupled to the shaft of the left solenoid 433. The front side end of the open/close link 434 is in contact with the left end of the rear surface of the front plate 432.

As shown in FIG. 11 and FIG. 12, the lower clamp 440 has a similar structure to the upper clamp 430. The lower clamp 440 includes a rear plate 441, a front plate 442, a left solenoid 443, an open/close link 444, a right solenoid 445, an open/close link 446, a pair of sliding portions (not shown in the drawings) and the pair of coupling shafts 439. The rear plate 441 can move along the rear rails 415 and 416 via the pair of sliding portions (not shown in the drawings). The front plate 442 is arranged to the front of the rear plate 441 via the pair of coupling shafts 439.

The open/close links 444 and 446 are respectively arranged in through holes 441A and 441B that are formed in the rear plate 441. A clearance between the rear plate 441 and the front plate 442 that face each other in the front-rear direction is an operation area 440A. The rear plate 441 and the front plate 442 respectively have guide surfaces that are similar to the guide surfaces 430B and 430C. The open/close link 444 is coupled to a shaft of the left solenoid 443 and is in contact with the left end of the rear surface of the front plate 442. The open/close link 446 is coupled to a shaft of the right solenoid 445 and is in contact with the right end of the rear surface of the front plate 442.

The operation areas 430A and 440A are spaces which extend in the left-right direction and through which the cover sheet 9 that is supplied to the cover sheet holding unit 400 can pass. The operation areas 430A and 440A face each other in the up-down direction and have the same shape in a plan view. The length of each of the operation areas 430A and 440A in the left-right direction is larger than the length of the cover sheet 9 in the left-right direction. The central position of each of the operation areas 430A and 440A in the left-right direction substantially matches the central position, in the left-right direction, of the cover sheet 9 supplied from the cover sheet supply portion 6, and substantially matches the central position of the table 110 in the left-right direction.

As shown in FIG. 11, the movable portion 401 includes a lifting motor 450, pulleys 451 and 452, a belt 453, a coupling portion 454 and the positioning plate 455. The lifting motor 450 is provided to the right of the upper end of the support frame 413. The lifting motor 450 has a shaft (not shown in the drawings) that penetrates the support frame 413 and extends to the left. The pulley 451 is provided at the leading end of the shaft of the lifting motor 450. The pulley 452 is provided to the left of the lower end of the support frame 413. The pulleys 451 and 452 face each other in the up-down direction to the left of the support frame 413.

The belt 453 is stretched between the pulleys 451 and 452. The coupling portion 454 is provided on the left end of the front surface of the rear plate 441, and is coupled to the belt 453. The positioning plate 455 is a plate-like body which is provided on the right side surface of the support frame 414 and which extends in the front-rear direction. The positioning plate 455 can support a positioning protrusion (not shown in the drawings), which is provided on the front surface of the rear plate 431, from below.

The movable portion 401 includes an abutment plate 460, the lifting motor 490, a screw shaft 491 and a second clamp 404. The lifting motor 490 is provided substantially at the center, in the left-right direction, of the top surface of the coupling frame 419. The screw shaft 491 penetrates the coupling frame 419 and extends downward from the lifting motor 490. The lower end of the screw shaft 491 is rotatably supported at the center lower end of the rear surface of the support plate 411.

The abutment plate 460 is a plate-like body that extends in the up-down direction and the left-right direction, and has a rectangular shape whose long side extends in the left-right direction. The abutment plate 460 is provided substantially at the center of the support plate 411 in the up-down direction, and to the rear of the front rails 417 and 418 and the screw shaft 491. The abutment plate 460 is disposed so as to extend in the left-right direction between the support frames 413 and 414. The length of the abutment plate 460 in the up-down direction is larger than the length, in the up-down direction, of the front end face of the bundle of paper sheets 8 placed on the placement surface 110A.

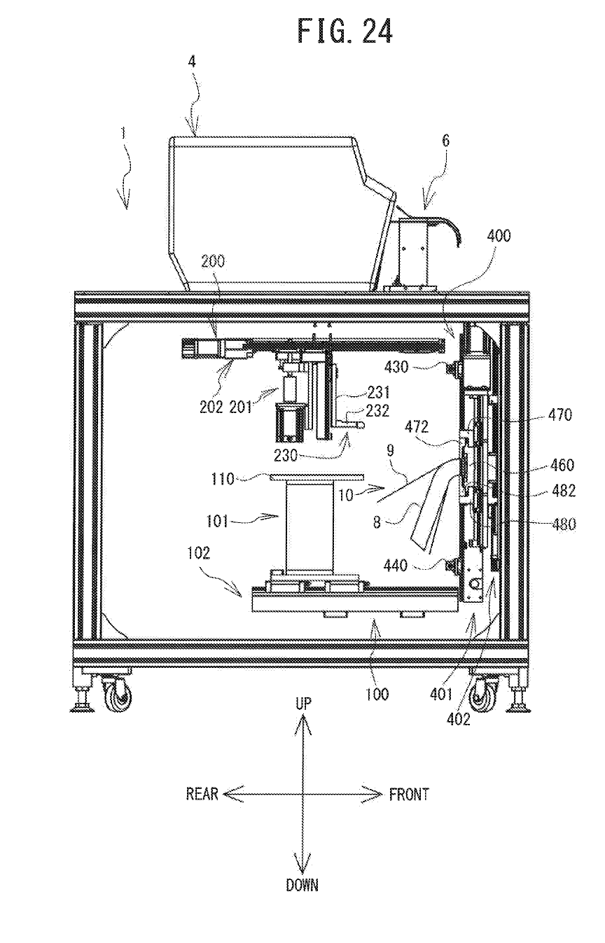

The second clamp 404 can clamp, from above and below, a book 10 (refer to FIG. 24) in which the bundle of paper sheets 8 is cased into the cover sheet 9. The second clamp 404 includes the upper clamp 470 and the lower clamp 480. The upper clamp 470 and the lower clamp 480 are disposed to face each other in the up-down direction such that the abutment plate 460 is interposed between them. The upper clamp 470 and the lower clamp 480 selectively clamp and release the book 10 by the upward and downward movement of each of them.

The upper clamp 470 includes a movable body 471, a clamp body 472, a pair of sliding portions 473 and a nut (not shown in the drawings). The movable body 471 is substantially a column-shaped body that extends in the left-right direction from the rear side of the front rail 417 to the rear side of the front rail 418. The pair of sliding portions 473 are respectively provided on the left end and the right end of the front surface of the movable body 471. Each of the sliding portions 473 is a sliding member that can move along a corresponding one of the front rails 417 and 418. The nut (not shown in the drawings) is provided substantially at the central portion of the front surface of the movable body 471, and the screw shaft 491 is inserted through the nut. The clamp body 472 is a plate-like body which is provided on the rear surface of the movable body 471 and which protrudes to the lower side of the movable body 471. The clamp body 472 extends in the up-down direction and the left-right direction, and has a rectangular shape whose long side extends in the left-right direction.

The lower clamp 480 has a similar structure to that of the upper clamp 470, and the upper clamp 470 and the lower clamp 480 are substantially vertically symmetric. The lower clamp 480 includes a movable body 481, a clamp body 482, a pair of sliding portions 483 and a nut (not shown in the drawings). The movable body 481 is coupled to the front rails 417 and 418 via the pair of sliding portions 483, and is coupled to the screw shaft 491 via the nut (not shown in the drawings). Note, however, that when the screw shaft 491 rotates in one direction, the direction of a linear motion into which a rotary motion of the screw shaft 491 is converted by the nut of the movable body 471 is opposite to the direction of a linear motion into which a rotary motion of the screw shaft 491 is converted by the nut of the movable body 481. The clamp body 482 is a plate-like body which is provided on the rear surface of the movable body 481 and which protrudes to the upper side of the movable body 481.

The central position of the abutment plate 460 in the left-right direction and the central position of each of the clamp bodies 472 and 482 in the left-right direction substantially match the central position in the left-right direction of the cover sheet 9 supplied from the cover sheet supply portion 6, and also substantially match the central position of the table 110 in the left-right direction. The abutment plate 460 and the clamp bodies 472 and 482 extend in the left-right direction, across a range that includes the cover sheet 9 supplied from the cover sheet supply portion 6, in the left-right direction.

With the above-described structure, the cover sheet holding unit 400 can perform the following operations. Ascending and descending operations of the movable portion 401 will be explained with reference to FIG. 10. When the conveyance motor 422 drives and rotates a screw shaft (not shown in the drawings), the support plate 411 provided with a nut (not shown in the drawings) moves in the up-down direction along the pair of guide rails 423. The movable portion 401 moves in the up-down direction in front of the movable range of the table 110. The movable portion 401 can move upward to a position where the movable portion 401 protrudes above the main body frame 2 via the cover sheet supply opening 22. A movable range of the movable portion 401 includes the reference position. The reference position is a position of the movable portion 401 in the up-down direction where the abutment plate 460 covers the whole of the bundle of paper sheets 8 on the placement surface 110A, in a front view.

Ascending and descending operations of the first clamp 403 will be explained with reference to FIG. 11. When the lifting motor 450 drives and rotates the shaft (not shown in the drawings), the lower clamp 440 provided with the coupling portion 454 moves in the up-down direction along the rear rails 415 and 416, via the pulleys 451 and 452 and the belt 453. When the lower clamp 440 is not in contact with the upper clamp 430, the upper clamp 430 is held in the upper reference position. The upper reference position is a position of the upper clamp 430 in the up-down direction where the positioning protrusion (not shown in the drawings) of the upper clamp 430 is supported by the positioning plate 455. In other words, the positioning plate 455 is provided higher than a contact position that will be described later, and restricts the downward movement of the upper clamp 430.

When the lower clamp 440 moves upward, it comes into contact with the upper clamp 430 located in the upper reference position, from below, and moves upward in a state in which the lower clamp 440 supports the upper clamp 430. That is, the upper clamp 430 can move upward from the upper reference position by being pressed by the lower clamp 440 that moves upward. The upper clamp 430 and the lower clamp 440 move to the upper end of each of their movable ranges in a state in which they are aligned in the up-down direction.

When the lower clamp 440 moves downward from the upper end of its movable range, the upper clamp 430 supported by the lower clamp 440 moves downward to the upper reference position by its own weight. When the upper clamp 430 reaches the upper reference position, the downward movement of the upper clamp 430 is restricted by the positioning plate 455. Thus, the lower clamp 440 is separated from the upper clamp 430 and moves downward. The lower clamp 440 moves to the lower end of its movable range via the lower reference position. The lower reference position is a position of the lower clamp 440 in the up-down direction where the upper reference position and the lower reference position are vertically symmetric with the abutment plate 460 being interposed therebetween. In other words, the distance from the abutment plate 460 to the upper reference position is substantially the same as the distance from the abutment plate 460 to the lower reference position. Note that the distance from the upper reference position to the lower reference position is slightly smaller than the length in the up-down direction of the cover sheet 9 that is supplied to the cover sheet holding unit 400.

A clamp operation of the first clamp 403 will be explained with reference to FIG. 12 to FIG. 14. As shown in FIG. 12 and FIG. 13, when the right solenoid 435 retracts the shaft 435A, the end 436B is moved in the left direction via the coupling shaft 436D. At this time, as the open/close link 436 swings around the shaft 436A, the end 436C moves forward and urges the front plate 432 forward. In a similar manner, when the left solenoid 433 retracts the shaft, the open/close link 434 urges the front plate 432 forward. Therefore, when the left solenoid 433 and the right solenoid 435 are both turned on, the front plate 432 moves forward along the coupling shaft 439 against the urging force of the coil spring 439A. As the front plate 432 is separated from the rear plate 431, the operation area 430A is opened.

As shown in FIG. 14, when the right solenoid advances the shaft 435A, the end 436B is moved to the right via the coupling shaft 436D. At this time, as the open/close link 436 swings around the shaft 436A, the end 436C moves rearward. The front plate 432 moves rearward along the coupling shaft 439 due to the urging force of the coil spring 439A. In a similar manner, when the left solenoid 433 advances the shaft, the front plate 432 moves rearward. Therefore, when the left solenoid 433 and the right solenoid 435 are both turned off, the front plate 432 comes close to the rear plate 431 due to the urging force of the coil spring 439A, and the operation area 430A is closed.

A clamp operation of the lower clamp 440 is similar to the clamp operation of the upper clamp 430. When the left solenoid 443 and the right solenoid 445 are both turned on, the operation area 440A is opened. When the left solenoid 443 and the right solenoid 445 are both turned off, the operation area 440A is closed.

Ascending and descending operations of the second clamp 404 will be explained with reference to FIG. 11. When the lifting motor 490 drives and rotates the screw shaft 491, the movable body 471 that is provided with a nut (not shown in the drawings) moves in the up-down direction along the front rails 417 and 418. At the same time, the movable body 481 that is provided with a nut (not shown in the drawings) moves in a direction opposite to the movable body 471 along the front rails 417 and 418. In other words, the clamp bodies 472 and 482 move with vertical symmetry in a direction to approach each other or a direction to separate from each other, with the abutment plate 460 being interposed between them.

The movable body 471 can move downward to a position where it comes into contact with the upper end of the abutment plate 460. When the movable body 471 has moved to the lower end of its movable range, the clamp body 472 protrudes slightly lower than the upper end of the abutment plate 460. The movable body 481 can move upward to a position where it comes into contact with the lower end of the abutment plate 460. When the movable body 481 has moved to the upper end of its movable range, the clamp body 482 protrudes slightly higher than the lower end of the abutment plate 460. When the movable body 471 has moved to the lower end of its movable range and the movable body 481 has moved to the upper end of its movable range, the distance between the clamp bodies 472 and 482 in the up-down direction (namely, the clearance between the clamp bodies 472 and 482) is smallest. At this time, the distance between the clamp bodies 472 and 482 in the up-down direction is smaller than the length of the book 10 in the up-down direction.

### 8. Detailed Structure of Cutting Unit 500

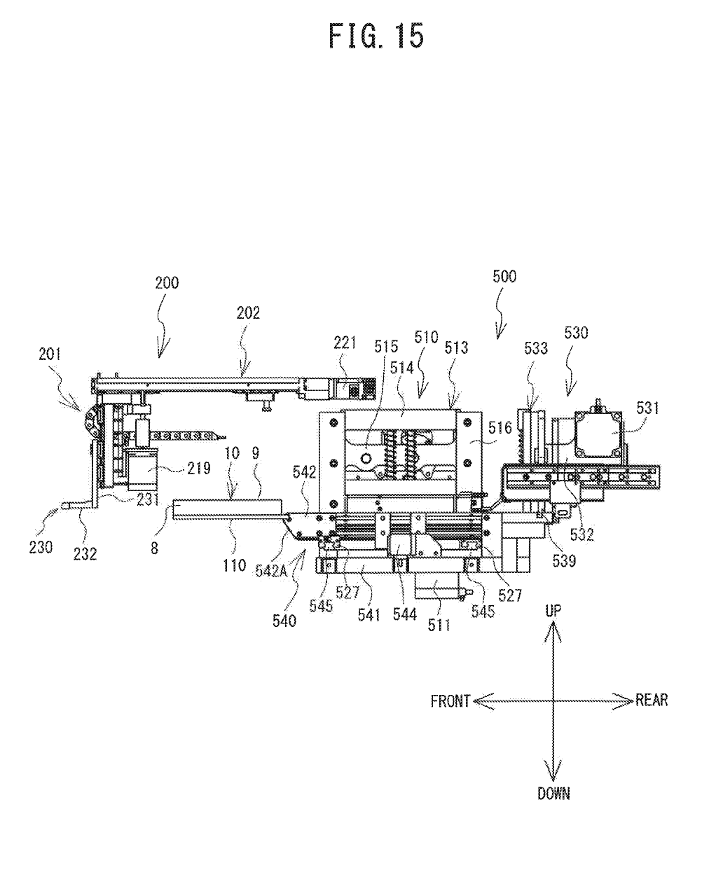

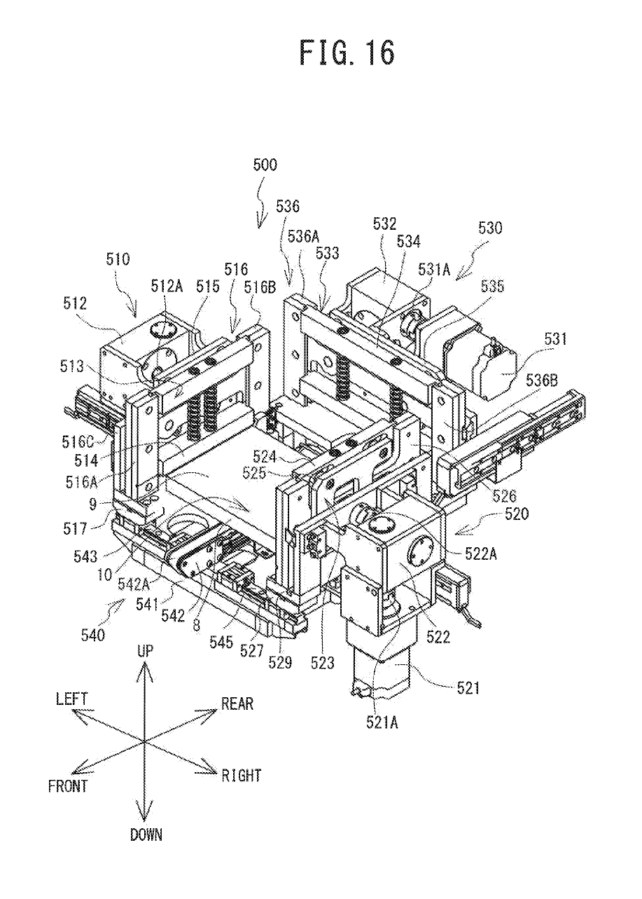

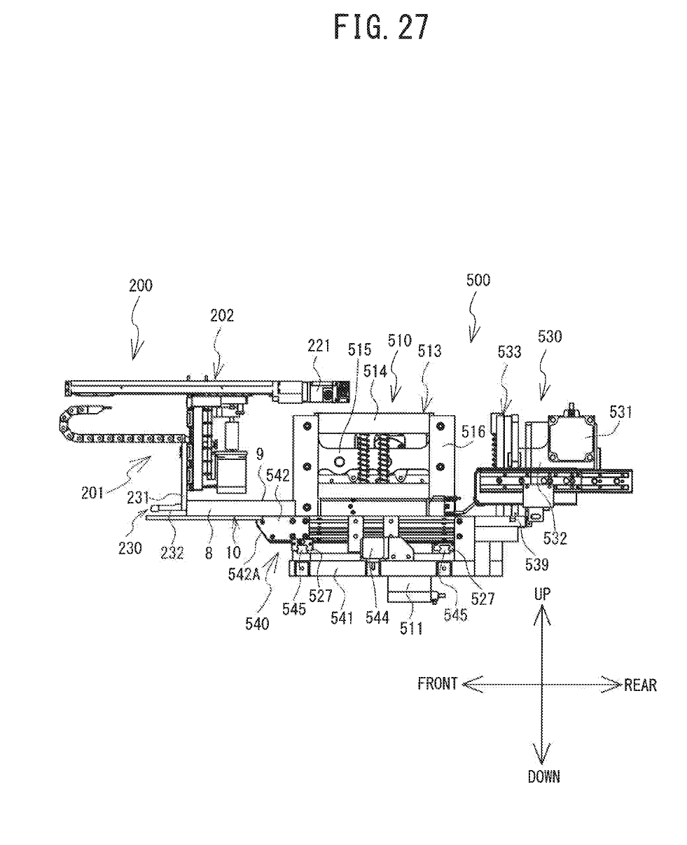

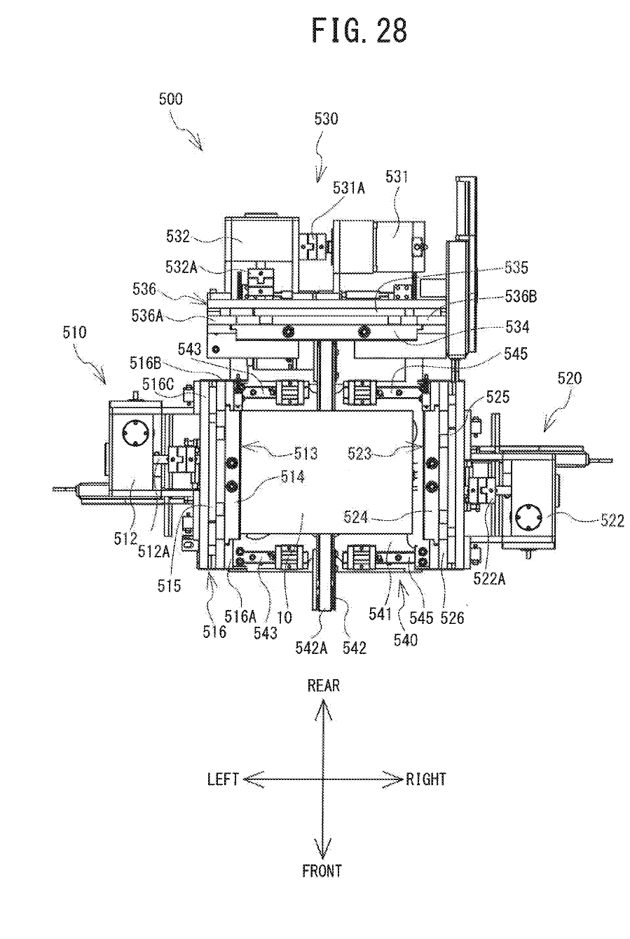

The structure of the cutting unit 500 will be explained in detail with reference to FIG. 15, FIG. 16 and FIG. 28. In the cutting unit 500 shown in FIG. 15, a right cutting portion 520 is omitted, apart from sliding portions 527 (this also applies to FIG. 27 to be explained later). In FIG. 15, the front alignment plate 231 is in the paper alignment position and the table 110 is in a fourth conveyance position that will be described later. In FIG. 15, FIG. 16 and FIG. 28, a left cutting portion 510 is located at the left end of its movable range, the right cutting portion 520 is located at the right end of its movable range, and cutting members 513, 523 and 533 are respectively located at the upper ends of their movable ranges.

As shown in FIG. 15, FIG. 16 and FIG. 28, the cutting unit 500 is arranged to the rear of the table 110 in the first conveyance position. The cutting unit 500 includes the left cutting portion 510, the right cutting portion 520, a rear cutting portion 530 and a drive portion 540. The left cutting portion 510 cuts off the left end face of the book 10 (refer to FIG. 24). The right cutting portion 520 cuts off the right end face of the book 10. The rear cutting portion 530 cuts off the rear end face of the book 10. The drive portion 540 performs various types of operations of the left cutting portion 510, the right cutting portion 520 and the rear cutting portion 530.

The drive portion 540 includes a base portion 541, a belt conveyor 542, a pair of left rails 543, a screw shaft 544, a pair of right rails 545 and a conveyance motor (not shown in the drawings). The base portion 541 is a plate-like body having a substantially square shape in a front view. The base portion 541 is coupled and fixed to the main body frame 2 in a state in which the base portion 541 is disposed on a rear side part of the main body frame 2. The belt conveyor 542 is provided at the center in the left-right direction of the top surface of the base portion 541, and extends across the whole of the base portion 541 in the front-rear direction. The front end of the belt conveyor 542 protrudes to the front of the base portion 541.

The belt conveyor 542 causes a circular belt 542A to rotate clockwise or counterclockwise in a side view. A section of the belt 542A that moves on the top surface side of the belt conveyor 542 is a conveyance surface. The conveyance surface of the belt 542A extends in the front-rear direction slightly above the placement surface 110A. The position of the conveyance surface of the belt 542A in the left-right direction substantially matches the central position of the table 110 in the left-right direction

The pair of left rails 543 are provided to the left of the belt conveyor 542 on the top surface of the base portion 541, and extend in the left-right direction such that they are aligned in the front-rear direction. The pair of right rails 545 are provided to the right of the belt conveyor 542 on the top surface of the base portion 541, and extend in the left-right direction such that they are aligned in the front-rear direction. The pair of left rails 543 and the pair of right rails 545 are arranged with left-right symmetry, with the belt conveyor 542 being interposed between them. The shaft screw 544 is provided on the top surface of the base portion 541 such that the shaft screw 544 is arranged between the pair of left rails 543 and is also arranged between the pair of right rails 545. The shaft screw 544 penetrates the belt conveyor 542 and extends in the left-right direction from the left end to the right end of the base portion 541. The conveyance motor (not shown in the drawings) driver and rotates the screw shaft 544.

The left cutting portion 510 includes a drive motor 511, a power conversion portion 512, the cutting member 513, a support portion 516, a pair of sliding portions 517, a nut (not shown in the drawings) and a cutting board (not shown in the drawings). The support portion 516 includes support pillars 516A and 516B and a coupling plate 516C. The support pillars 516A and 516B are column-shaped bodies that extend in the up-down direction such that they are aligned in the front-rear direction. The coupling plate 516C is a plate-like body which is coupled to the support pillars 516A and 516B from the left side, and which extends in the front-rear direction. The pair of sliding portions 517 are respectively provided on the lower end of the support pillar 516A and the lower end of the support pillar 516B. Each of the sliding portions 517 is a sliding member that can move along a corresponding one of the left rails 543. The nut (not shown in the drawings) is provided on the lower end of the coupling plate 516C, and the screw shaft 544 is inserted through the nut.

The power conversion portion 512 is provided to the left of the coupling plate 516C. The drive motor 511 is provided below the power conversion portion 512. A shaft (not shown in the drawings) that extends upward from the drive motor 511 is connected to the power conversion portion 512. The power conversion portion 512 converts a rotary motion around an axis extending in the up-down direction that is output from the shaft (not shown in the drawings) of the drive motor 511 into a rotary motion around an axis extending in the left-right direction. A shaft 512A that extends to the right from the power conversion portion 512 is connected to the cutting member 513. The cutting member 513 is supported such that it can move in the up-down direction between the support pillars 516A and 516B.

The cutting member 513 includes a retaining member 514 and a cutting blade 515. The cutting blade 515 is a blade which can cut off the bundle end face of the book 10 in the up-down direction and which extends in the front-rear direction. The retaining member 514 is a member that presses the book 10 from above along the cutting blade 515. The length of the retaining member 514 and the cutting blade 515 in the front-rear direction is larger than the length of the book 10 in the front-rear direction. The retaining member 514 is coupled to the right side of the cutting blade 515.

In a state in which the retaining member 514 does not press the book 10, the lower end of the retaining member 514 is located lower than the lower end of the cutting blade 515. When the cutting member 513 is located at the upper end of its movable range, the distance in the up-down direction between the lower end of the retaining member 514 and the conveyance surface of the belt 542A is larger than the length of the book 10 in the up-down direction. The cutting board (not shown in the drawings) is supported below the cutting blade 515 by the support portion 516. The cutting board (not shown in the drawings) is a plate-shaped member which receives the leading edge of the cutting blade 515 and which is provided at the same height as the conveyance surface of the belt 542A.

As shown in FIG. 16 and FIG. 28, the right cutting portion 520 has a similar structure to that of the left cutting portion 510, and the left cutting portion 510 and the right cutting portion 520 are substantially left-right symmetric. The right cutting portion 520 includes a drive motor 521, a power conversion portion 522, the cutting member 523, a support portion 526, the pair of sliding portions 527, a nut (not shown in the drawings) and a cutting board 529. The support portion 526 is coupled to the pair of right rails 545 via the pair of sliding portions 527. The screw shaft 544 is inserted through the nut (not shown in the drawings). Note, however, that when the screw shaft 544 rotates in one direction, the direction of a linear motion into which a rotary motion of the screw shaft 544 is converted by the nut of the right cutting portion 520 is opposite to the direction of a linear motion into which a rotary motion of the screw shaft 544 is converted by the nut of the left cutting portion 510.

A shaft 521A that extends upward from the drive motor 521 is connected to the power conversion portion 522. A shaft 522A that extends to the left from the power conversion portion 522 is connected to the cutting member 523. The cutting member 523 includes a retaining member 524 and a cutting blade 525. The cutting board 529 is a plate-shaped member which receives the leading edge of the cutting blade 525 and which is supported below the cutting blade 525 by the support portion 526.

The rear cutting portion 530 includes a drive motor 531, a power conversion portion 532, the cutting member 533, a support portion 536 and a cutting board 539 (refer to FIG. 15). The support portion 536 includes support pillars 536A and 536B. The support pillars 536A and 536B are column-shaped bodies that extend in the up-down direction such that they are arranged side by side in the left-right direction. The support pillar 536A is provided on the left end of the top surface of the base portion 541 and to the rear of the left cutting portion 510. The support pillar 536B is provided on the right end of the top surface of the base portion 541 and to the rear of the right cutting portion 520. The power conversion portion 532 is provided to the rear of the support pillar 536A.

The drive motor 531 is provided to the right of the power conversion portion 532. A shaft (not shown in the drawings) that extends to the left from the drive motor 531 is connected to the power conversion portion 532. The power conversion portion 532 converts a rotary motion around an axis extending in the left-right direction that is output from the shaft 531A of the drive motor 531 into a rotary motion around an axis extending in the front-rear direction. A shaft 532A that extends to the front from the power conversion portion 532 is connected to the cutting member 533. The cutting member 533 is supported such that it can move in the up-down direction between the support pillars 536A and 536B.

The cutting member 533 includes a retaining member 534 and a cutting blade 535. The cutting blade 535 is a blade which can cut off the book 10 in the up-down direction and which extends in the left-right direction. The retaining member 534 is a member that presses the book 10 from above along the cutting blade 535. The length of the retaining member 534 and the cutting blade 535 in the left-right direction is larger than the length of the book 10 in the left-right direction. The retaining member 534 is coupled to the front side of the cutting blade 535.

In a state in which the retaining member 534 does not press the book 10, the lower end of the retaining member 534 is located lower than the lower end of the cutting blade 535. When the cutting member 533 is located at the upper end of its movable range, the distance in the up-down direction between the lower end of the retaining member 534 and the conveyance surface of the belt 542A is larger than the length of the book 10 in the up-down direction. The cutting board 539 is supported below the cutting blade 535 by the support portion 536. The cutting board 539 is a plate-shaped member which receives the leading edge of the cutting blade 535 and which is provided at the same height as the conveyance surface of the belt 542A.

With the above-described structure, when the belt conveyor 542 drives and rotates the belt 542A, a target object on the conveyance surface of the belt 542A moves in the front-rear direction. When the conveyance motor (not shown in the drawings) drives and rotates the screw shaft 544, the support portion 516 that is provided with a nut (not shown in the drawings) moves in the left-right direction along the pair of left rails 543. At the same time, the support portion 526 that is provided with a nut (not shown in the drawings) moves in a direction opposite to the support portion 516 along the pair of right rails 545.

In other words, the left cutting portion 510 and the right cutting portion 520 move with left-right symmetry in a direction to approach each other or a direction to separate from each other, with the belt conveyor 542 being interposed between them. When the left cutting portion 510 has moved to the left end of its movable range and the right cutting portion 520 has moved to the right end of its movable range, the distance in the left-right direction between the left cutting portion 510 and the right cutting portion 520 is largest. At this time, the distance between the left cutting portion 510 and the right cutting portion 520 in the left-right direction is larger than the length of the book 10 in the left-right direction.

When the drive motor 511 drives and rotates the shaft (not shown in the drawings), the rotary motion converted by the power conversion portion 512 causes the cutting member 513 to move in the up-down direction. When the drive motor 521 drives and rotates the shaft 521A, the rotary motion converted by the power conversion portion 522 causes the cutting member 523 to move in the up-down direction. When the drive motor 531 drives and rotates the shaft 531A, the rotary motion converted by the power conversion portion 532 causes the cutting member 533 to move in the up-down direction.

### 9. Bookbinding Operations of Bookbinding Apparatus 1

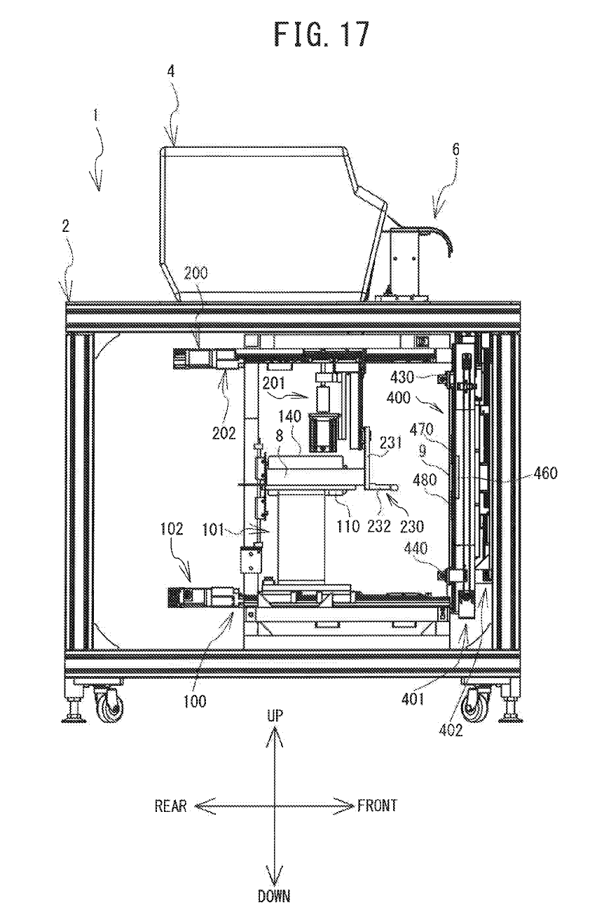

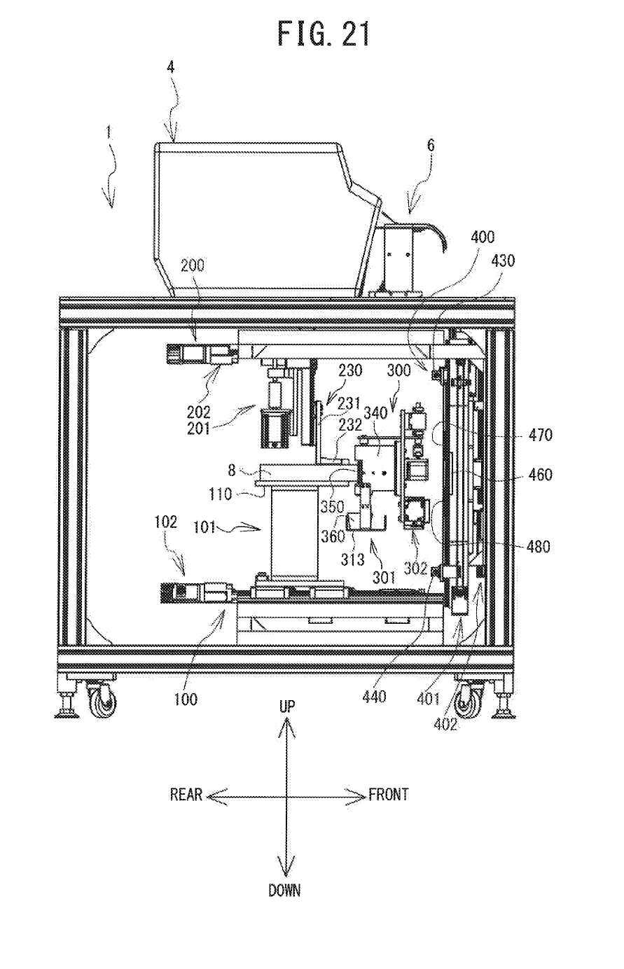

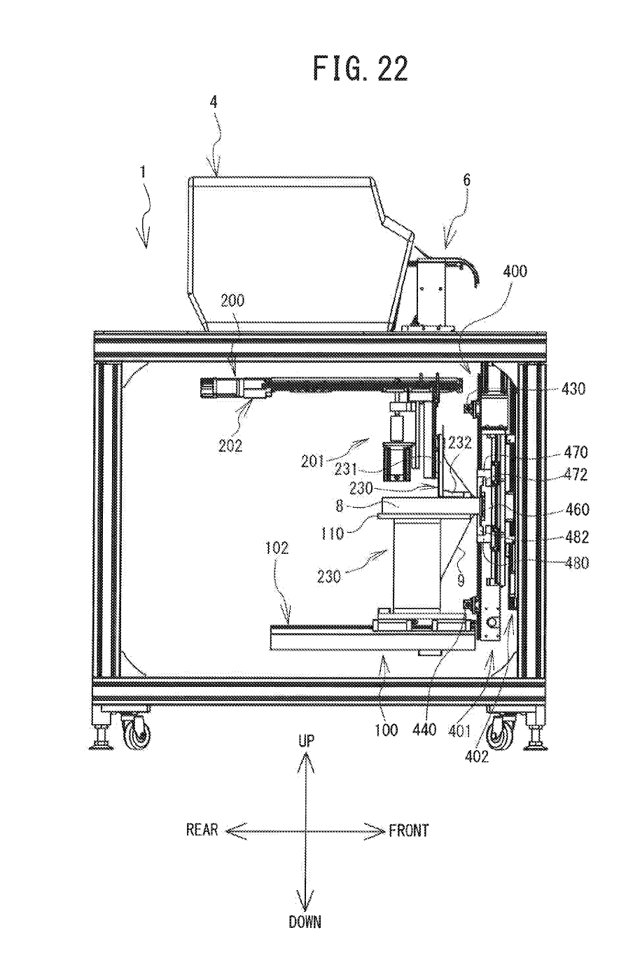

Bookbinding operations of the bookbinding apparatus 1 will be explained with reference to FIG. 17 to FIG. 30. FIG. 17, FIG. 21, FIG. 22, and FIG. 24 to FIG. 26 are left side views of the bookbinding apparatus 1, and show structures that are necessary to explain each of operation states. When the user inputs a command to the control portion 900 to start the bookbinding operations, the following bookbinding operations are performed under the control of the control portion 900. First, the bookbinding apparatus 1 is returned to the initial state. The bundle operation unit 200, the gluing unit 300, the cover sheet holding unit 400 and the cutting unit 500 are each controlled and returned to the initial state.

When the paper alignment unit 100 is controlled and returned to the initial state, the table 110 is positioned in the first conveyance position. The left alignment plate 130 and the right alignment plate 140 are each positioned in the separated position. The rear alignment plate 150 is positioned in the raised position and the separated position (refer to FIG. 5 to FIG. 7). When the bundle operation unit 200 is controlled and returned to the initial state, the front alignment plate 231 is positioned in the paper alignment position (refer to FIG. 5 and FIG. 7). When the gluing unit 300 is controlled and returned to the initial state, the glue applying portion 340 is positioned in the retracted position. The rotation of the glue applying roller 350 is stopped (refer to FIG. 5, FIG. 8 and FIG. 9).

When the cover sheet holding unit 400 is controlled and returned to the initial state, the movable portion 401 is positioned in the reference position. In the first clamp 403, the upper clamp 430 is positioned in the upper reference position and the lower clamp 440 is positioned in the lower reference position. The operation areas 430A and 440A are both closed. In the second clamp 404, the upper clamp 470 is positioned at the upper end of its movable range and the lower clamp 480 is positioned at the lower end of its movable range (refer to FIG. 10 to FIG. 14). When the cutting unit 500 is controlled and returned to the initial state, the left cutting portion 510 is positioned at the left end of its movable range and the right cutting portion 520 is positioned at the right end of its movable range. The cutting members 513, 523 and 533 are respectively positioned at the upper ends of their movable ranges (refer to FIG. 15, FIG. 16 and FIG. 28).

Next, the first printer 3 prints images that are represented in the content of the book on the plurality of paper sheets 8A. The paper sheet supply portion 5 conveys the printed paper sheets 8A toward the paper alignment unit 100. The paper sheets 8A are discharged from the paper sheet supply portion 5 onto the placement surface 110A by the plurality of conveyance rollers 56. As shown in FIG. 5 to FIG. 7, the discharged paper sheets 8A fall into the area whose four sides are surrounded by the left alignment plate 130, the right alignment plate 140, the rear alignment plate 150 and the front alignment plate 231, and are stacked on the placement surface 110A. The plurality of paper sheets 8A stacked in the order of printing on the placement surface 110A form the bundle of paper sheets 8 on the placement surface 110A. Since the paper sheets 8A are somewhat larger than the placement surface 110A, the bundle of paper sheets 8 on the placement surface 110A slightly protrudes in the front-rear direction and the left-right direction from the table 110 in a plan view.

As shown in FIG. 17, after all the paper sheets 8A have been supplied to the placement surface 110A, the left alignment plate 130 is moved to the right from the separated position and the right alignment plate 140 is moved to the left from the separated position. The left alignment plate 130 comes into contact with the left end face of the bundle of paper sheets 8 that protrudes to the left of the table 110. The left end face of the bundle of paper sheets 8 is aligned along the right surface of the left alignment plate 130. The right alignment plate 140 comes into contact with the right end face of the bundle of paper sheets 8 that protrudes to the right of the table 110. The right end face of the bundle of paper sheets 8 is aligned along the left surface of the right alignment plate 140. The left alignment plate 130 and the right alignment plate 140 press the bundle of paper sheets 8 from both the left and right sides, and thus cause the central position of the bundle of paper sheets 8 in the left-right direction to match the central position of the table 110 in the left-right direction.

The rear alignment plate 150 is moved forward from the separated position. The rear alignment plate 150 comes into contact with the rear end face of the bundle of paper sheets 8 that protrudes to the rear of the table 110, and presses the bundle of paper sheets 8 to the front. The rear end face of the bundle of paper sheets 8 is aligned along the front surface of the rear alignment plate 150. At this time, the front end face of the bundle of paper sheets 8 that protrudes to the front of the table 110 is pressed against the rear surface of the front alignment plate 231. The front end face of the bundle of paper sheets 8 is aligned along the rear surface of the front alignment plate 231. As described above, the position in the front-rear direction of the rear surface of the front alignment plate 231 that is in the paper alignment position substantially matches the position in the front-rear direction of the glue application surface of the glue applying roller 350. Therefore, the aligned front end face of the bundle of paper sheets 8 is positioned within the glue application area of the glue applying portion 340.

Before (or during) the execution of one of the printing of the paper sheets 8A and the paper alignment of the bundle of paper sheets 8 that have been described above, the following operation is performed. As shown in FIG. 18, the second printer 4 prints a cover sheet image of the book on the cover sheet 9. In the cover sheet holding unit 400, the movable portion 401 is moved upward from the reference position and is positioned in a receiving position. The receiving position is a position of the movable portion 401 in the up-down direction where the movable portion 401 protrudes higher than the main body frame 2 via the cover sheet supply opening 22 (refer to FIG. 1) and the upper end of the movable range of the upper clamp 430 is located directly below the path outlet 65.

The upper clamp 430 and the lower clamp 440 are moved to the upper ends of their movable ranges, respectively. The operation areas 430A and 440A are both opened. The printed cover sheet 9 is guided by the cover sheet supply portion 6 toward the cover sheet supply opening 22. The cover sheet 9 discharged from the path outlet 65 enters the operation area 430A of the upper clamp 430 that is located directly below the path outlet 65, and further enters the operation area 440A of the lower clamp 440 that is located directly below the upper clamp 430. Both the upper ends of the operation areas 430A and 440A have a large opening width in the front-rear direction due to the above-described guide surfaces 430B and 430C. For that reason, the cover sheet 9 easily enters the operation areas 430A and 440A.

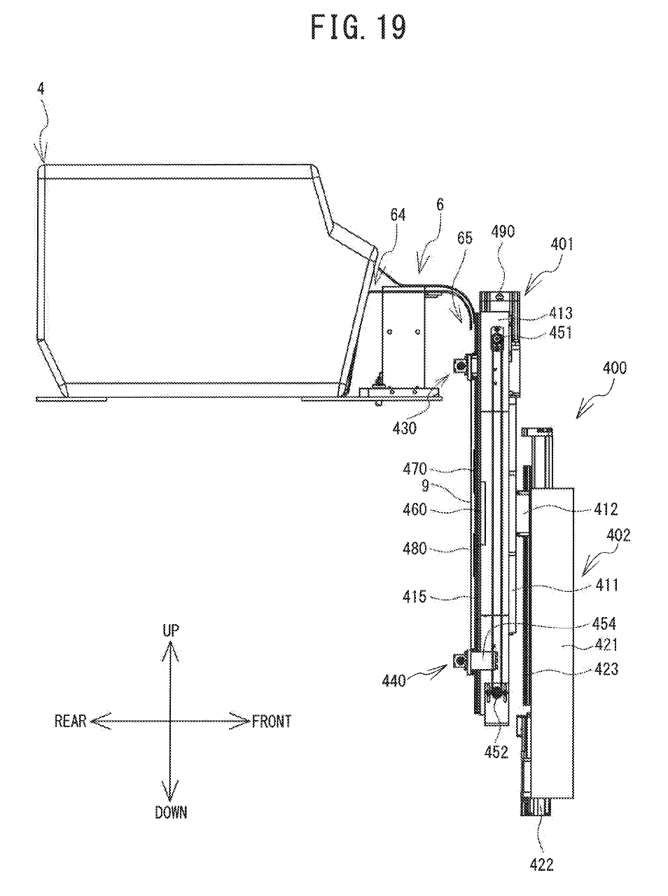

As shown in FIG. 19, when a lower side portion of the cover sheet 9 enters the operation area 440A, the operation area 440A is closed. The lower side portion of the cover sheet 9 is clamped between the rear plate 441 and the front plate 442. The lower clamp 440 is moved downward in a state in which it has clamped the lower side portion of the cover sheet 9. In accordance with the movement of the lower clamp 440, the upper clamp 430 moves downward to the upper reference position by its own weight in a state in which the cover sheet 9 is inserted in the operation area 430A. After the upper clamp 430 has reached the upper reference position, the lower clamp 440 is separated from the upper clamp 430 and is moved downward to the lower reference position. When the lower clamp 440 is positioned in the lower reference position, the operation area 430A is closed. An upper side portion of the cover sheet 9 is clamped between the rear plate 431 and the front plate 432. In other words, the upper clamp 430 and the lower clamp 440 hold the cover sheet 9 in a posture in which the cover sheet 9 extends in the up-down direction and the left-right direction.

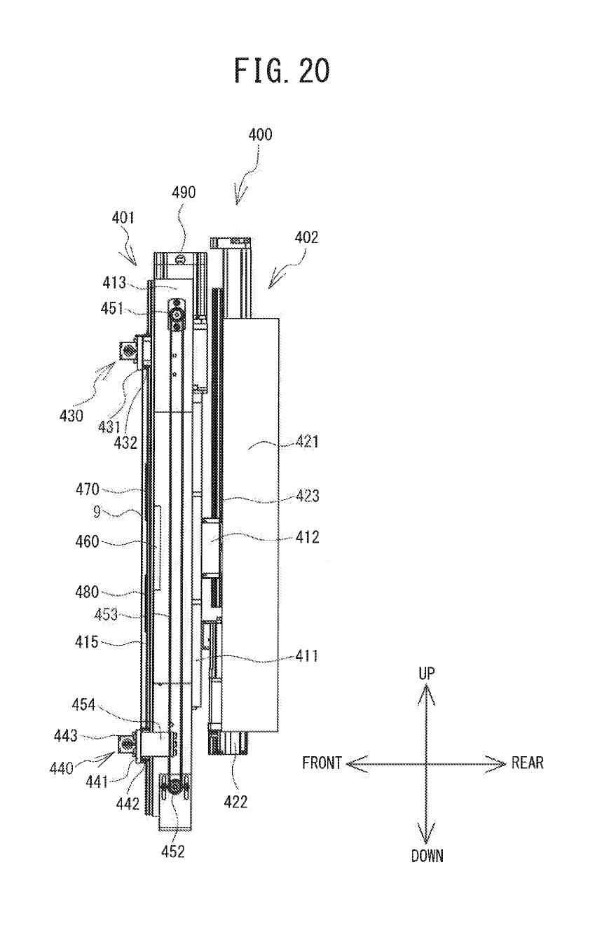

As shown in FIG. 20 and FIG. 21, the movable portion 401 that holds the cover sheet 9 is moved downward to the reference position. Meanwhile, after the paper alignment of the bundle of paper sheets 8 is performed, the bundle operation portion 230 is moved upward from the first vertical position to the second vertical position. Further, the bundle operation portion 230 is moved rearward from the first horizontal position to a second horizontal position. The second horizontal position is a position of the bundle operation portion 230 in the front-rear direction where the position of the front end of the retaining plate 232 substantially matches the position of the front end of the table 110 in the first conveyance portion, in the front-rear direction. The bundle operation portion 230 is moved downward from the second vertical position after it has reached the second horizontal position. The lower surface of the retaining plate 232 comes into contact with the top surface of the bundle of paper sheets 8 and presses the bundle of paper sheets 8 downward. At this time, the retaining plate 232 is in a position (a paper retaining position) where the front end vicinity of the bundle of paper sheets 8 is clamped between the retaining plate 232 and the table 110.

After the retaining plate 232 is moved to the paper retaining position, the glue applying roller 350 is driven and rotated and the glue applying portion 340 is moved to the left from the retracted position. More specifically, the glue applying portion 340 moves to a position where it faces the front end face of the bundle of paper sheets 8 along the left-right direction, from a state in which it is retracted to a position that is separated rightward from the front end face of the bundle of paper sheets 8. The glue applying portion 340 applies the glue 7 from the front side of the bundle of paper sheets 8 within the glue application area. Specifically, the glue application surface of the glue applying roller 350 comes into contact with the front end face of the bundle of paper sheets 8 that has been positioned and aligned by the front alignment plate 231, and applies the glue 7 to the front end face of the bundle of paper sheets 8. The glue applying portion 340 moves reciprocatingly a plurality of times in the left-right direction within the movable range of the table 110. By doing this, a sufficient amount of the glue 7 is applied across the whole of the front end face of the bundle of paper sheets 8. The glue 7 applied to the front end face of the bundle of paper sheets 8 forms the adhesive portion of the cover sheet 9. After that, the glue applying portion 340 returns to the retracted position.

Next, the table 110 is moved forward from the first conveyance position, and the bundle operation portion 230 is moved forward from the second horizontal position in synchronization with the table 110. The bundle operation portion 230 is moved at the same moving speed as the table 110 by the same movement distance as the table 110. Thus, without changing the paper retaining position, the retaining plate 232 moves while clamping the bundle of paper sheets 8 with the front end of the table 110. The table 110 is moved forward to the second conveyance position. The second conveyance position is a position of the table 110 in the front-rear direction where the front end face of the bundle of paper sheets 8 is pressed by the abutment plate 460.

The table 110 passes through a third conveyance position during the movement from the first conveyance position to the second conveyance position. The third conveyance position is a position of the table 110 in the front-rear direction where the front end face of the bundle of paper sheets 8 comes into contact with the cover sheet 9. A position where the adhesive portion formed on the front end face of the bundle of paper sheets 8 and the cover sheet 9 come into contact with each other is referred to as a contact position. The upper clamp 430 holds the upper side portion of the cover sheet 9 above the contact position. The lower clamp 440 holds the lower side portion of the cover sheet 9 below the contact position. When the table 110 reaches the third conveyance position, the front end face of the bundle of paper sheets 8 pressed by the retaining plate 232 comes into contact with the rear surface of the cover sheet 9 held by the upper clamp 430 and the lower clamp 440. The cover sheet 9 is adhered to the adhesive portion formed on the front end face of the bundle of paper sheets 8.

When the table 110 moves from the third conveyance position to the second conveyance position, the operation areas 430A and 440A are opened. In accordance with the movement of the table 110 from the third conveyance position to the second conveyance position, the upper side portion of the cover sheet 9 released from the upper clamp 430 exits downward from the operation area 430A. At the same time, the lower side portion of the cover sheet 9 released from the lower clamp 440 exits upward from the operation area 440A. After the operation area 440A is opened, the lower clamp 440 in the lower reference position is moved to the lower end of its movable range. In other words, after the upper side portion and the lower side portion of the cover sheet 9 are released, the lower clamp 440 is moved in a direction in which it is separated from the contact position. When the table 110 reaches the second conveyance position, the front end face of the bundle of paper sheets 8 pressed by the retaining plate 232 is pressed by the abutment plate 460 via the cover sheet 9. Thus, the cover sheet 9 is reliably adhered to the adhesive portion of the bundle of paper sheets 8.

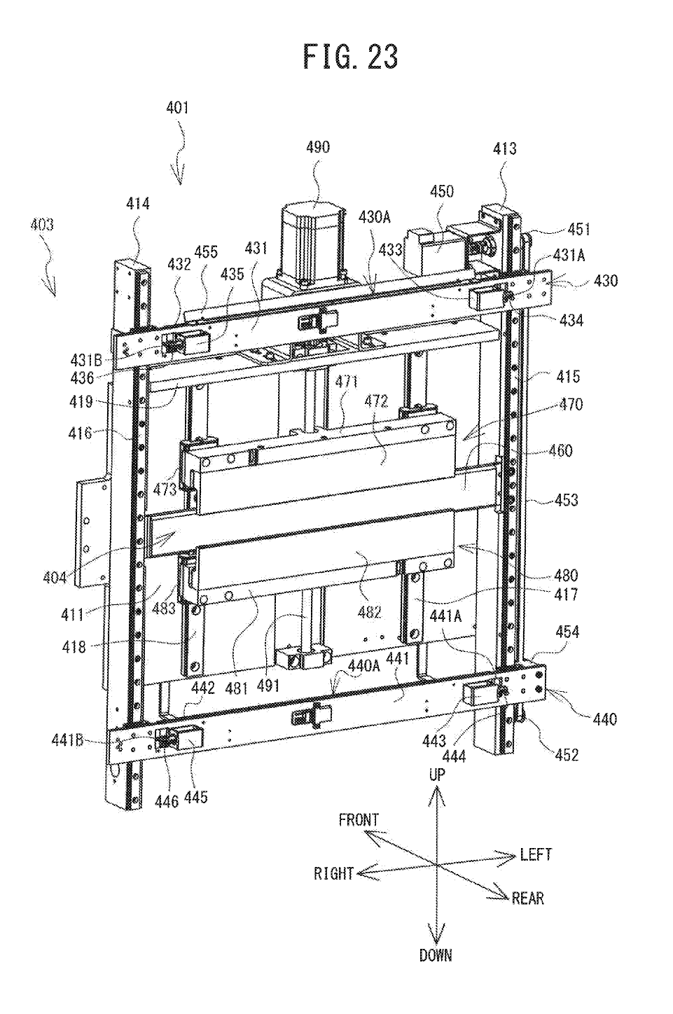

As shown in FIG. 22 and FIG. 23, when the table 110 moves to the second conveyance position, the upper clamp 470 and the lower clamp 480 are moved in a direction in which they approach each other. The clamp body 472 of the upper clamp 470 that moves downward presses the cover sheet 9 against the front edge of the top surface of the bundle of paper sheets 8, and folds an upper side part of the cover sheet 9 rearward. The clamp body 482 of the lower clamp 480 that moves upward presses the cover sheet 9 against the front edge of the lower surface of the bundle of paper sheets 8, and folds a lower side part of the cover sheet 9 rearward. By doing this, the book 10 that is the bundle of paper sheets 8 cased into the cover sheet 9 is made. The clamp bodies 472 and 482 clamp the front end of the book 10 from both the upper and lower sides, to the rear of the abutment plate 460.

Next, as shown in FIG. 24, the bundle operation portion 230 is moved upward toward the second vertical position, and the retaining plate 232 is separated from the book 10. Further, the bundle operation portion 230 is moved rearward to the second horizontal position, and the table 110 is moved from the second conveyance position toward the first conveyance position. The book 10 that is separated from the table 110 hangs down, rearward and downward, by its own weight in a state in which the front end of the book 10 is clamped by the clamp bodies 472 and 482.

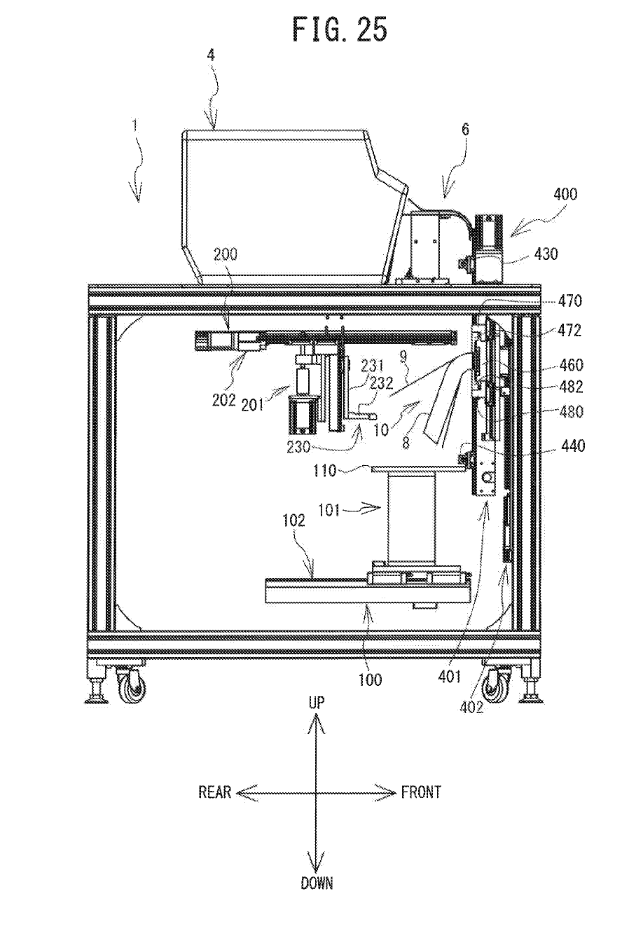

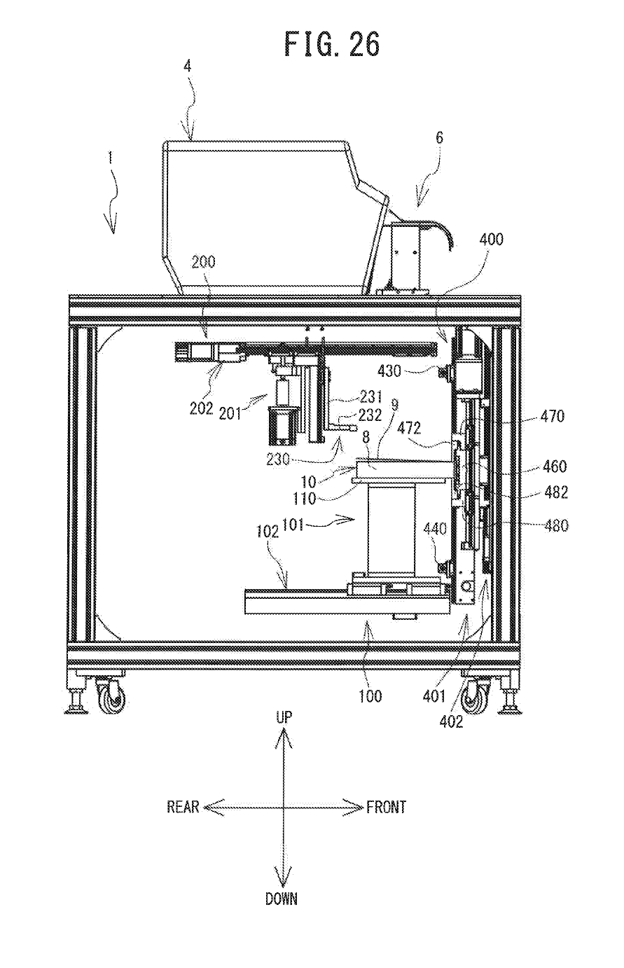

Next, as shown in FIG. 25, the movable portion 401 is moved upward from the reference position to the receiving position. After the movable portion 401 has reached the receiving position, the table 110 is moved from the first conveyance position toward the second conveyance position. The table 110 is moved to below the book 10 that is clamped by the clamp bodies 472 and 482. As shown in FIG. 26, after the table 110 has reached the second conveyance position, the movable portion 401 is moved downward from the receiving position toward the reference position. The book 10 clamped by the clamp bodies 472 and 482 is placed on the placement surface 110A.

After that, the clamp bodies 472 and 482 move in a direction in which they separate from each other. The clamping of the book 10 by the clamp bodies 472 and 482 is released. Note that it is preferable that the clamp bodies 472 and 482 clamp the book 10 over a period of time that is necessary for the adhesive portion to sufficiently bond the cover sheet 9 and the front end face of the bundle of paper sheets 8. It is preferable that known anti-slip processing is applied to the clamp bodies 472 and 482 so that they can reliably clamp the book 10.

Next, as shown in FIG. 15, the table 110 is moved rearward from the third conveyance position to a fourth conveyance position. The fourth conveyance position is a position of the table 110 in the front-rear direction where the front end of the belt conveyor 542 is inserted into the slit 110B of the table 110. After the table 110 is positioned in the fourth conveyance position, the bundle operation portion 230 is moved downward from the second vertical position to a third vertical position. When the bundle operation portion 230 is in the third vertical position, the retaining plate 232 is located slightly higher than the placement surface 110A. At this time, the front alignment plate 231 is arranged slightly in front of the book 10 on the placement surface 110A.

Further, as shown in FIG. 27, the bundle operation portion 230 is moved rearward by a predetermined distance from the second horizontal position. The rear surface of the front alignment plate 231 comes into contact with the front end face of the book 10, and presses the book 10 to move rearward. The book 10 is moved toward the belt conveyor 542 inserted in the slit 110B, and is placed on the conveyance surface of the belt 542A.

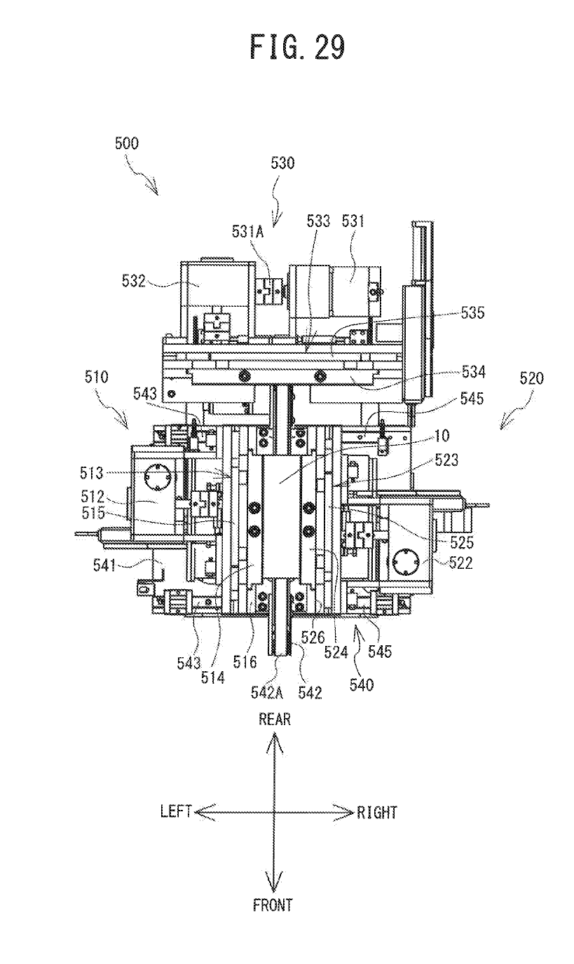

As shown in FIG. 28, the belt conveyor 542 drives and rotates the belt 542A, and conveys the book 10 rearward to a first cutting position. The first cutting position is a position of the book 10 in the front-rear direction where the book 10 is located between the left cutting portion 510 and the right cutting portion 520. As shown in FIG. 29, after the book 10 has reached the first cutting portion, the left cutting portion 510 and the right cutting portion 520 are moved in a direction in which they approach each other. At this time, the cutting members 513 and 523 respectively pass above the book 10, and are positioned in positions in the left-right direction that correspond to the length in the left-right direction of the book to be made.

After the cutting member 513 is positioned, the cutting member 513 is moved downward from the upper end of its movable range. At this time, the retaining member 514 presses the book 10 from above. Along the retaining member 514 that presses the book 10, the cutting blade 515 moves downward to a position where the leading edge of the cutting blade 515 reaches the cutting board (not shown in the drawings). The left end face of the book 10 on the cutting board (not shown in the drawings) is cut off in the up-down direction by the cutting blade 515. After that, the cutting member 513 is moved upward to the upper end of its movable range. The cut left end face (namely, a left part of the book 10 that has been divided into left and right parts by the cutting blade 515) falls down below the main body frame 2 by its own weight.

In a similar manner, after the cutting member 523 is positioned, the cutting member 523 is moved downward from the upper end of its movable range. Along the retaining member 524 that presses the book 10, the cutting blade 525 moves downward to a position where the leading edge of the cutting blade 525 reaches the cutting board 529. The right end face of the book 10 on the cutting board 529 is cut off by the cutting blade 525 in the up-down direction. The cut right end face (namely, a right part of the book 10 that has been divided into left and right parts by the cutting blade 525) falls down below the main body frame 2 by its own weight. In the present embodiment, the left end face and the right end face of the book 10 are simultaneously cut off in the left cutting portion 510 and the right cutting portion 520. Note that, in the left cutting portion 510 and the right cutting portion 520, after one of the left end face and the right end face of the book 10 is cut off, the other of the left end face and the right end face of the book 10 may be cut off.

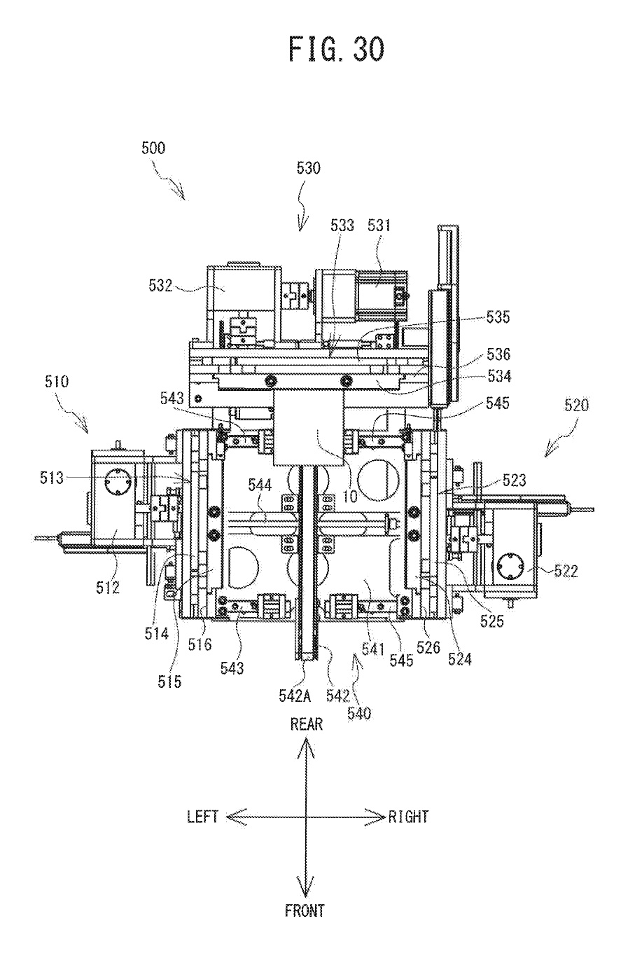

Next, as shown in FIG. 30, the left cutting portion 510 and the right cutting portion 520 are moved in a direction in which they separate from each other until they respectively reach the left end and the right end of their movable ranges. The belt conveyor 542 drives and rotates the belt 542A, and conveys the book 10, whose left end face and right end face have been cut off, rearward to a second cutting position. The second cutting position is a position of the book 10 in the front-rear direction where the book 10 is located directly below the cutting member 533. The book 10 passes below the cutting member 533, and is positioned in a position in the front-rear direction that corresponds to the length in the front-rear direction of the book to be made.

After the book 10 has reached the second cutting position, the cutting member 533 is moved downward from the upper end of its movable range. Along the retaining member 534 that presses the book 10, the cutting blade 535 moves downward to a position where the leading edge of the cutting blade 535 reaches the cutting board 539. The rear end face of the book 10 on the cutting board 539 is cut off by the cutting blade 535 in the up-down direction. The cut rear end face (namely, a rear part of the book 10 that has been divided into front and rear parts by the cutting blade 535) falls down below the main body frame 2 by its own weight. After that, the cutting member 533 is moved upward to the upper end of its movable range.

Thus, the bundle end faces of the book 10, other than the front end face to which the cover sheet 9 has been adhered, are cut and a desired size of the book is made. The belt conveyor 542 drives and rotates the belt 542A and conveys the made book to a discharge position that is located to the rear of the second cutting position. The discharge position is located at the rear end of the cutting unit 500 and is located to the rear of the main body frame 2. The user takes out the made book conveyed to the discharge position.

### 10. Examples of Operational Effects of Bookbinding Apparatus 1

(1) The bookbinding apparatus 1 is provided with the paper alignment unit 100, the gluing unit 300, the cover sheet supply portion 6, the cover sheet holding unit 400 and the control portion 900. The paper alignment unit 100 is configured to hold the bundle of paper sheets 8 that is a plurality of paper sheets 8A stacked in the up-down direction and to convey the bundle of paper sheets 8 in the front-rear direction that is orthogonal to the up-down direction. The gluing unit 300 is configured to form the adhesive portion on the front end face of the bundle of paper sheets 8 that is held by the paper alignment unit 100. The cover sheet supply portion 6 is configured to supply the cover sheet 9 to the cover sheet supply opening 22. The cover sheet holding unit 400 is configured to hold the cover sheet 9 supplied to the cover sheet supply opening 22 by the cover sheet supply portion 6 in a state in which the cover sheet 9 and the adhesive portion formed by the gluing unit 300 face each other in the front-rear direction. The control portion 900 is configured to cause the paper alignment unit 100 to convey the bundle of paper sheets 8 toward the contact position where the adhesive portion comes into contact with the cover sheet 9, in a state in which the cover sheet 9 is held by the cover sheet holding unit 400.

The cover sheet holding unit 400 is provided with the upper clamp 430, the lower clamp 440 and the lifting motor 450. The upper clamp 430 is configured to hold the upper side portion of the cover sheet 9 supplied to the cover sheet supply opening 22, above the contact position. The lower clamp 440 is provided below the upper clamp 430. The lower clamp 440 is configured to hold the lower side portion of the cover sheet 9 supplied to the cover sheet supply opening 22, below the contact position. The lifting motor 450 is configured to move at least one of the upper clamp 430 and the lower clamp 440 in the up-down direction. In the above-described embodiment, the lower clamp 440 is moved by the lifting motor 450.

In a known bookbinding apparatus, a cover sheet and a cover are conveyed by many fixed rollers. There is therefore an increased possibility of a paper jam occurring in one of the fixed rollers. In contrast to this, with the above-described structure, the two clamps (the upper clamp 430 and the lower clamp 440) can hold the cover sheet 9 supplied to the cover sheet supply opening 22, and also can convey the held cover sheet 9 to an adhering position and position it in the adhering position. The adhering position is a position where the cover sheet 9 is adhered to the bundle of paper sheets 8. Therefore, the bookbinding apparatus 1 can suppress a paper jam of the cover sheet 9 when it conveys the cover sheet 9 to the adhering position, in comparison to a case in which the cover sheet is conveyed by the many fixed rollers as in the related art. The bookbinding apparatus 1 can accurately perform case binding with a simple and compact structure.

(2) The control portion 900 is configured to cause the lifting motor 450 to move at least one of the upper clamp 430 and the lower clamp 440, after the cover sheet 9 has been supplied to the cover sheet supply opening 22 and before the bundle of paper sheets 8 reaches the contact position. The control portion 900 is configured to position the upper clamp 430 above the contract position and to position the lower clamp 440 below the contact position. In the above-described embodiment, the lower clamp 440 is moved by the lifting motor 450 to the lower reference position, and the upper clamp 430 is moved by its own weight to the upper reference position.

With the above-described structure, the cover sheet 9 supplied to the cover sheet supply opening 22 is conveyed to and positioned in the adhering position before the bundle of paper sheets 8 is moved to the contact position. Therefore, the bookbinding apparatus 1 can attach the cover sheet 9 to the front end face of the bundle of paper sheets 8 by moving the bundle of paper sheets 8 to the contact position.

(3) The control portion 900 is configured to cause the lifting motor 450 to move at least one of the upper clamp 430 and the lower clamp 440 before the cover sheet 9 is supplied to the cover sheet supply opening 22. The control portion 900 is configured to cause the upper clamp 430 and the lower clamp 440 to approach each other at the cover sheet supply opening 22. In the above-described embodiment, the lower clamp 440 is moved toward the cover sheet supply opening 22 by the lifting motor 450, and the upper clamp 430 is moved toward the cover sheet supply opening 22 by the lower clamp 440.

With the above-described structure, in a state in which the distance of separation between the upper clamp 430 and the lower clamp 440 is small, the cover sheet 9 supplied to the cover sheet supply opening 22 is held by the upper clamp 430 and the lower clamp 440. Therefore, the bookbinding apparatus 1 can reduce the possibility of the occurrence of the paper jam of the cover sheet 9 between the upper clamp 430 and the lower clamp 440.

(4) The control portion 900 is configured to cause the paper alignment unit 100 to convey the bundle of paper sheets 8 forward from the contact position, after the bundle of paper sheets 8 has been conveyed to the contact position. The control portion 900 is configured to cause the upper clamp 430 to release the holding of the cover sheet 9 and also to cause the lower clamp 440 to release the holding of the cover sheet 9, when the bundle of paper sheets 8 is conveyed forward from the contact position by the paper alignment unit 100. The control portion 900 is configured to cause the paper alignment unit 100 to move at least one of the upper clamp 430 and the lower clamp 440 in a direction to be separated from the contact position, after the holding of the cover sheet 9 by the upper clamp 430 and the lower clamp 440 is released. In the above-described embodiment, the lower clamp 440 is moved downward from the lower reference position by the lifting motor 450 such that the lower clamp 440 is separated from the contact position.

With the above-described structure, when the bundle of paper sheets 8 to which the cover sheet 9 has been adhered is conveyed forward from the contact position, the holding of the cover sheet 9 by the upper clamp 430 and the lower clamp 440 is released and at least one of the upper clamp 430 and the lower clamp 440 is moved in a direction to be separated from the contact position. The cover sheet 9 adhered to the bundle of paper sheets 8 is smoothly released from the upper clamp 430 and the lower clamp 440. Thus, the bookbinding apparatus 1 can smoothly convey the bundle of paper sheets 8 to which the cover sheet 9 has been adhered, forward from the contact position.

(5) The upper clamp 430 is provided with the operation area 430A, the rear plate 431, and the front plate 432. The operation area 430A is an area through which the cover sheet 9 supplied to the cover sheet supply opening 22 can pass. The rear plate 431 and the front plate 432 are configured to clamp a part of the cover sheet 9 that passes through the operation area 430A. The lower clamp 440 is provided with the operation area 440A, the rear plate 441, and the front plate 442. The operation area 440A is an area through which the cover sheet 9 supplied to the cover sheet supply opening 22 can pass. The rear plate 441 and the front plate 442 are configured to clamp a part of the cover sheet 9 that passes through the operation area 440A. The control portion 900 is configured to cause the rear plate 441 and the front plate 442 to clamp the lower side part of the cover sheet 9 that passes through the operation area 440, and thereafter to cause the rear plate 431 and the front plate 432 to clamp the upper side part of the cover sheet 9 that passes through the operation area 430A, when the cover sheet 9 is supplied to the cover sheet supply opening 22.

With the above-described structure, before the upper side part of the cover sheet 9 is clamped by the upper clamp 430, the bookbinding apparatus 1 causes the lower clamp 440 that clamps the lower side part of the cover sheet 9 to move downward such that the lower clamp 440 is separated from the upper clamp 430. At this time, as the lower clamp 440 conveys the cover sheet 9 toward the adhering position, the upper side part of the cover sheet 9 moves to the operation area 430A. Therefore, the bookbinding apparatus 1 can convey the cover sheet 9 toward the adhering position and also can hold the cover sheet 9 in the adhering position, without using the many conveyance rollers as in the related art.

(6) The rear rails 415 and 416 pass through the contact position and extend in the up-down direction, and the length of the rear rails 415 and 416 is equal to or larger than the length of the cover sheet 9 in the up-down direction. The rear rails 415 and 416 are configured to guide the upper clamp 430 and the lower clamp 440 in the up-down direction. The positioning plate 455 is provided above the contact position, and is configured to restrict the downward movement of the upper clamp 430. The upper clamp 430 is configured to move downward to the positioning plate 455 by a external force (the own weight of the upper clamp 430 in the above-described embodiment) along the rear rails 415 and 416. The upper clamp 430 is configured to move upward from the positioning plate 455 by being pressed by the lower clamp 440 that moves upward.

With the above-described structure, while the lower clamp 440 is moved by the lifting motor 450, the upper clamp 430 is moved by the external force or by the lower clamp 440. Thus, the bookbinding apparatus 1 can move the upper clamp 430 and the lower clamp 440 in the up-down direction just by using the lifting motor 450 to move the lower clamp 440, and it is possible to reduce the number of the lifting motors 450.

(7) The bookbinding apparatus 1 is provided with the table 110, the front alignment plate 231 and the glue applying portion 340. The table 110 has the placement surface 110A which extends in the horizontal direction. The placement surface 110A is configured to hold the bundle of paper sheets 8 on the placement surface 110A. The bundle of paper sheets 8 is the plurality of paper sheets 8A held on the placement surface 110A and stacked in the up-down direction that is orthogonal to the horizontal direction. The front alignment plate 231 has the rear surface which extends in the up-down direction. The front alignment plate 231 is configured to come into contact with the front end face, which is the end face on the front side, in the horizontal direction, of the bundle of paper sheets 8. The glue applying portion 340 is configured to apply the glue 7 to the bundle of paper sheets 8 from the front side, within the glue application area extending along the left-right direction that is orthogonal to the up-down direction and to the front direction.

The front alignment plate 231 is configured to come into contact with the front end face of the bundle of paper sheets 8, and thereby aligns the front end face of the bundle of paper sheets 8 to be substantially flush with each other along the up-down direction within the glue application area. The glue applying portion 340 is configured to apply the glue 7 within the glue application area to form on the front end face of the bundle of paper sheets 8 aligned by the front alignment plate 231. The adhesive portion is a portion to which the cover sheet 9 that is configured to cover the bundle of paper sheets 8 can be adhered,

With the known bookbinding apparatus, after the end face of intermediate paper sheets is aligned by a stopper, the intermediate paper sheets are conveyed to the next process step. Since the posture and the position of the intermediate paper sheets change significantly during this conveyance, there is a possibility that the end face of the intermediate paper sheets aligned by the stopper changes to an irregular state. In contrast to this, with the above-described structure, the front end face of the bundle of paper sheets 8 on the placement surface 110A is aligned by the front alignment plate 231 to be substantially flush with each other along the up-down direction within the glue application area. The glue applying portion 340 form the adhesive portion on the front end face of the bundle of paper sheets 8 by applying the glue 7 within the glue application area. Therefore, after the front end face of the bundle of paper sheets 8 is aligned to be substantially flush with each other along the up-down direction, the bookbinding apparatus 1 can accurately form the adhesive portion to which the cover sheet 9 can be adhered, without changing the position and the posture of the bundle of paper sheets 8. The bookbinding apparatus 1 can accurately perform case binding with a simple and compact structure.

(8) The glue applying portion 340 is configured to move to a position where it faces the front end face of the bundle of paper sheets 8 along the left-right direction, from a position (in the above-described embodiment, the retracted position that is located to the right of the front end face of the bundle of paper sheets 8) that is separated from the front end face of the bundle of paper sheets 8 in the left-right direction, when the glue applying portion 340 applies the glue 7 within the glue application area. With the above-described structure, simply by moving in the left-right direction, the glue applying portion 340 can be displaced between the position where it faces the front end face of the bundle of paper sheets 8 and the position where it is separated from the front end face of the bundle of paper sheets 8. Thus, the bookbinding apparatus 1 can adjust a timing at which the adhesive portion is formed on the front end face of the bundle of paper sheets 8, simply by controlling the movement of the glue applying portion 340.

(9) The front alignment plate 231 is configured to separate from the front end face of the bundle of paper sheets 8 after the front alignment plate 231 aligns the front end face of the bundle of paper sheets 8. The glue applying portion 340 applies the glue 7 within the glue application area after the front alignment plate 231 is separated from the front end face of the bundle of paper sheets 8. With the above-described structure, after the front alignment plate 231 that has aligned the front end face of the bundle of paper sheets 8 is retracted, the glue 7 is applied within the glue application area. The bookbinding apparatus 1 can therefore inhibit the application of the glue 7 to the front end face of the bundle of paper sheets 8 from being obstructed by the front alignment plate 231.

(10) The paper alignment unit 100 is configured to convey the bundle of paper sheets 8 in the forward direction after the adhesive portion is formed by the glue applying portion 340. The cover sheet holding unit 400 is configured to attach the cover sheet 9 to the adhesive portion of the bundle of paper sheets 8 that has been conveyed in the forward direction by the paper alignment unit 100. With the above-described structure, the position of the bundle of paper sheets 8 on which the adhesive portion has been formed is changed only in the forward direction, and then the cover sheet 9 is adhered. Therefore, after the adhesive portion is formed on the front end face of the bundle of paper sheets 8, the bookbinding apparatus 1 can accurately attach the cover sheet 9 to the front end face of the bundle of paper sheets 8, without changing the posture of the bundle of paper sheets 8.

(11) The paper alignment unit 100 is configured to convey the bundle of paper sheets 8 in the rearward direction after the cover sheet 9 is attached to the adhesive portion by the cover sheet holding unit 400. The cutting unit 500 is configured to cut the bundle of paper sheets 8 conveyed in the rearward direction by the paper alignment unit 100. With the above-described structure, the bundle of paper sheets 8 to which the cover sheet 9 has been adhered is cut after the position of the bundle of paper sheets 8 is changed only in the rearward direction. Therefore, after the cover sheet 9 is adhered to the front end face of the bundle of paper sheets 8, the bundle of paper sheets 8 is not rotated around an axis extending in the up-down direction, and the bookbinding apparatus 1 can accurately cut the bundle of paper sheets 8 to which the cover sheet 9 has been adhered.

(12) The glue receiving member mounting portion 313 is configured to hold the glue receiving member 360 below the glue applying portion 340. The glue receiving member 360 is configured to receive some of the glue 7 that has dropped, of the glue 7 that is applied within the glue application area. With the above-described structure, the glue 7 that does not adhere to the front end face of the bundle of paper sheets 8 drops and is accumulated in the glue receiving member 360. Thus, the bookbinding apparatus 1 can suppress the unnecessary glue 7 from splashing.

(13) The glue applying portion 340 is a movable body that is configured to apply the glue 7 within the glue application area while moving in the left-right direction over at least the length of the bundle of paper sheets 8 in the left-right direction. With the above-described structure, the glue applying portion 340 applies the glue 7 to the whole of the front end face of the bundle of paper sheets 8 while moving in the left-right direction. Therefore, the bookbinding apparatus 1 can apply the glue 7 to the whole of the front end face of the bundle of paper sheets 8 using the glue applying portion 340 that is compact and occupies little space.

(14) The glue applying portion 340 is provided with the glue storage portion 342, the roller mounting portion 343, the glue applying roller 350 and the glue application opening 346. The glue storage portion 342 has a bottomed box shape whose horizontal cross-sectional area gradually decreases downward, and can store the glue 7 therein. The roller mounting portion 343 is communicatively connected with the glue storage portion 342 (at least from a lower portion of the glue storage portion 342 to the rear), and the glue 7 stored in the glue storage portion 342 flows into the inside of the roller mounting portion 343. The glue applying roller 350 is a substantially cylindrical body that rotates inside the roller mounting portion 343 around the lower shaft 352 and the upper shaft 353 that extend in the up-down direction. The glue applying roller 350 has the peripheral surface 351A to which the glue 7 stored in the glue storage portion 342 can attach. The glue application opening 346 is an opening that exposes the peripheral surface 351A of the glue applying roller 350 from the inside of the roller mounting portion 343 to the rear. The glue application area is an area to which the glue 7 can be applied using the peripheral surface 351A of the glue applying roller 350 that is exposed from the glue application opening 346.

With the above-described structure, the glue 7 stored inside the glue storage portion 342 easily moves to the lower portion of the glue storage portion 342, and is easily attached to the peripheral surface 351A of the glue applying roller 350 provided inside the roller mounting portion 343 from the lower portion of the glue storage portion 342. The peripheral surface 351A to which the glue 7 has been attached is exposed to the outside from the glue application opening 346, and can be used to apply the glue 7 within the glue application area. Accordingly, the bookbinding apparatus 1 can apply a sufficient amount of the glue 7 to the whole of the front end face of the aligned bundle of paper sheets 8 within the glue application area.

(15) The bookbinding apparatus 1 is provided with the table 110, the gluing unit 300, the cover sheet holding unit 400 and the cutting unit 500. The table 110 has the placement surface 110A that is a flat surface configured to hold the bundle of paper sheets 8. The bundle of paper sheets 8 is the plurality of paper sheets 8A held on the placement surface 110A and stacked in the up-down direction that is orthogonal to the placement surface 110A. The table 110 is configured to move parallel to the placement surface 110A, along the conveyance path that passes through the first conveyance position in which the plurality of paper sheets 8A are supplied to the table 110. The gluing unit 300 and the cover sheet holding unit 400 are provided forward of the first conveyance position. The gluing unit 300 and the cover sheet holding unit 400 are configured to bind the front end face of the bundle of paper sheets 8 held on the placement surface 110A.

The cutting unit 500 is provided rearward (which is a direction opposite to the forward direction) of the first conveyance position. The cutting unit 500 is configured to cut off at least the rear end face of the bundle of paper sheets 8 in the up-down direction. The table 110 is configured to move forward toward the second and third conveyance positions where the front end face of the bundle of paper sheets 8 is bound by the gluing unit 300 and the cover sheet holding unit 400, and move rearward toward the fourth conveyance position where the rear end face of the bundle of paper sheets 8 is cut off by the cutting unit 500.

With the known bookbinding apparatus, the intermediate paper sheets and the cover sheet are conveyed to an optimal operation area in the process step of binding and cutting a book. Therefore, many moving devices, such as moving rollers and belts, are provided. When many moving devices are provided in this manner, there is a possibility that the apparatus structure is complicated and increased in size.

In contrast to this, with the above-described structure, the table 110 can be displaced between the first conveyance position, the second and third conveyance positions, and the fourth conveyance position. The second and third conveyance positions and the fourth conveyance position are in opposite directions, with the first conveyance position interposed between them. The front end face of the bundle of paper sheets 8 held on the placement surface 110A is bound and the rear end face is cut off simply by the table 110, which does not move in the left-right direction, moving in the front-rear direction.

Therefore, the bookbinding apparatus 1 can perform bookbinding and cutting of a book while suppressing the apparatus structure from being complicated. Due to the linear movement of the table 110, the table 110 can take the shortest distance to move from the first conveyance position to the fourth conveyance position, without the bundle of paper sheets 8 held on the placement surface 110A being rotated around the axis extending in the up-down direction. The bookbinding apparatus 1 can accurately and rapidly perform bookbinding and cutting of the book. After the bundle of paper sheets 8 is held on the placement surface 110A, the bookbinding apparatus 1 can bind the front end face of the bundle of paper sheets 8 and can cut off the rear end face of the bundle of paper sheets 8. The bookbinding apparatus 1 can accurately perform case binding with a simple and compact structure.

(16) The placement surface 110A is a surface which extends in the horizontal direction and on which the plurality of paper sheets 8A are stacked in the up-down direction. The table 110 is configured to move in the forward direction and in the rearward direction in a state in which the table 110 holds the bundle of paper sheets 8 extending in the horizontal direction. With the above-described structure, the front end face of the bundle of paper sheets 8 held on the placement surface 110A is bound in a posture in which the bundle of paper sheets 8 extends in the horizontal direction, and the rear end face is cut off in the up-down direction in the posture in which the bundle of paper sheets 8 extends in the horizontal direction. Therefore, the bookbinding apparatus 1 can smoothly cut off the rear end face of the bundle of paper sheets 8 along the direction of the gravitational force, and can discharge slips of paper that are generated at the time of cutting, as a result of the slips of paper falling due to their own weight.

(17) The paper alignment unit 100 is configured to cause the table 110 to move from the first conveyance position to the second and third conveyance positions after the plurality of paper sheets 8A are supplied to the table 110. The paper alignment unit 100 is conjured to cause the table 110 to move from the second or third conveyance positions to the fourth conveyance position after the front end face is bound by the gluing unit 300 and the cover sheet holding unit 400. With the above-described structure, after the front end face of the bundle of paper sheets 8 is bound, the bundle of paper sheets 8 is conveyed without being rotated around the axis extending in the up-down direction, and the rear end face of the bundle of paper sheets 8 is cut off. Misalignment of the bundle of paper sheets 8 whose front end face is bound is unlikely to occur when the bundle of paper sheets 8 is cut, in comparison to the bundle of paper sheets 8 whose front end face is not bound. Thus, the bookbinding apparatus 1 can accurately cut off the rear end face of the bundle of paper sheets 8.

(18) The gluing unit 300 is configured to form the adhesive portion on the front end face of the bundle of paper sheets 8 held on the placement surface 110A when the table 110 is in the first conveyance position. The cover sheet holding unit 400 is configured to attach the cover sheet 9, which can cover the bundle of paper sheets 8, to the adhesive portion formed by the gluing unit 300 when the table 110 is in the second and third conveyance positions. With the above-described structure, after the bundle of paper sheets 8 is held on the placement surface 110A, the bookbinding apparatus 1 can accurately form the adhesive portion on the front end face of the bundle of paper sheets 8 without changing the position and the posture of the bundle of paper sheets 8. Further, after the adhesive portion is formed on the front end face of the bundle of paper sheets 8, the bookbinding apparatus 1 can attach the cover sheet 9 to the front end face of the bundle of paper sheets 8 with simple control that moves the table 110 forward without moving the table 110 in the left-right direction.

(19) The cutting unit 500 is provided with the cutting blades 515, 525 and 535. The cutting blade 535 is a blade configured to cut off the rear end face of the bundle of paper sheets 8. The cutting blades 515 and 525 are blades configured to cut off the left end face and the right end face, respectively, which are end faces of the bundle of paper sheets 8 in the left-right direction that is orthogonal to the up-down direction and to the rear direction. With the above-described structure, each of the end faces of the bundle of paper sheets 8 is cut off by a corresponding one of the cutting blades 515, 525 and 535. Therefore, the bookbinding apparatus 1 can accurately cut off each of the end faces of the bundle of paper sheets 8 without changing the posture of the bundle of paper sheets 8.

### 11. Modified Examples

(A) At least each of the above-described structures (1) to (6) may be modified in the following manner. It is sufficient that the paper alignment unit 100 is configured to hold a bundle of paper sheets that is a plurality of paper sheets stacked in a first direction and convey the bundle of paper sheets in a second direction that is orthogonal to the first direction. For example, the paper alignment unit 100 may be a carriage, a conveyance roller, a belt conveyor or the like that can convey the bundle of paper sheets. The first direction is not limited to the up-down direction and may be, for example, the left-right direction or the front-rear direction. The second direction is not limited to the front-rear direction and may be, for example, the left-right direction or the up-down direction.

It is sufficient that the gluing unit 300 is configured to form the adhesive portion on the end face, in the second direction, of the bundle of paper sheets that is held by the paper alignment unit 100. For example, the gluing unit 300 may be a mechanism for attaching a double-sided tape as the adhesive portion. It is sufficient that the cover sheet supply portion 6 is configured to supply a cover sheet that can cover the bundle of paper sheets to a predetermined supply position. The cover sheet supply portion 6 may be a printer, a carriage, a conveyance roller, a belt conveyor or the like that supplies the cover sheet. The predetermined supply position is not limited to the cover sheet supply opening 22, and it is sufficient that the predetermined supply position is a position where the cover sheet 9 can be supplied to the cover sheet holding unit 400.

It is sufficient that the cover sheet holding unit 400 is configured to hold the cover sheet supplied to the supply position by the cover sheet supply portion 6 in a state in which the cover sheet and the adhesive portion formed by the gluing unit 300 face each other in the second direction. For example, the cover sheet holding unit 400 may be a mechanism that includes a device (for example, a clip, a suction portion, an adhesive portion or the like) that can hold the cover sheet. The cover sheet holding unit 400 may be provided with three or more clamps that correspond to the upper clamp 430 and the lower clamp 440.

It is sufficient that the upper clamp 430 is configured to hold one end side of the cover sheet supplied to the supply position on one side in the first direction with respect to the contact position. It is sufficient that the lower clamp 440 is provided on the other side in the first direction with respect to the upper clamp 430, and that the lower clamp 440 is configured to hold the other end side of the cover sheet supplied to the supply position on the other side in the first direction with respect to the contact position. For example, the upper clamp 430 and the lower clamp 440 may be a clip, a suction portion, an adhesive portion or the like that can hold a part of the cover sheet.

In the above-described embodiment, a case is exemplified in which the upper clamp 430 is moved by a external force and by the lower clamp 440. Instead of this, the lower clamp 440 may be moved by a external force and by the upper clamp 430. The upper clamp 430 that is not moved by the lifting motor 450 may be fixed to a predetermined position (for example, the upper reference position). The external force is not limited to own weight, and may be, for example, a spring pressure, a magnetic force or the like.

It is sufficient that the lifting motor 450 is configured to move at least one of the upper clamp 430 and the lower clamp 440 in the first direction. For example, the lifting motor 450 may be a solenoid, a jack, an engine or the like. In the above-described embodiment, a case is exemplified in which the lifting motor 450 moves the lower clamp 440. Instead of this, the lifting motor 450 may move the upper clamp 430 or may move both the upper clamp 430 and the lower clamp 440.

(B) At least each of the above-described structures (7) to (14) may be modified in the following manner. It is sufficient that the front alignment plate 231 has a surface portion which extends in the up-down direction and which is configured to come into contact with the bundle end face, which is the end face of the bundle of paper sheets in the first direction in the horizontal direction, the bundle of paper sheets being the plurality of paper sheets held on the placement surface of the table. For example, the front alignment plate 231 may have a cuboid shape having a surface portion that extends in the up-down direction. The front alignment plate 231 is not limited to an alignment plate having a surface portion that is configured to come into contact with the whole of the bundle end face, and may be an alignment plate having a surface portion that is configured to come into contact with at least a part of the bundle end face along the up-down direction. The first direction is not limited to the front direction and may be, for example, the left direction, the right direction or the rear direction.

It is sufficient that the glue applying portion 340 is configured to apply an adhesive from the first direction side of the bundle of paper sheets to a third direction, which is a direction opposite to the first direction, within a predetermined area along the second direction that is orthogonal to the up-down direction and to the first direction. For example, the glue applying portion 340 may be a mechanism for spraying the adhesive. The second direction is not limited to the left-right direction and may be the front-rear direction, for example. The third direction is not limited to the rear direction and may be, for example, the left direction, the right direction or the front direction. The adhesive is not limited to the glue 7 and may be liquid that contains an adhesive component.

(C) At least each of the above-described structures (15) to (19) may be modified in the following manner. It is sufficient that the table 110 has a placement surface that is a flat surface that is configured to hold the bundle of paper sheets such that the plurality of paper sheets held on the placement surface and stacked in an orthogonal direction that is orthogonal to the placement surface. It is sufficient that the table 110 is configured to move parallel to the placement surface along the conveyance path that passes through the supply position to which the plurality of paper sheets are supplied. For example, the table 110 may be a carriage, a conveyance roller, a belt conveyor or the like that can move while holding the bundle of paper sheets on the placement surface. The orthogonal direction is not limited to the up-down direction and may be, for example, the front-rear direction or the left-right direction. When the orthogonal direction is the front-rear direction or the left-right direction, it is sufficient that the table 110 is moved in the up-down direction toward a binding position and a cutting position while holding the bundle of paper sheets on the placement surface. The binding position and the cutting position are provided in the up-down direction with the supply position being interposed therebetween.

It is sufficient that the gluing unit 300 and the cover sheet holding unit 400 are provided in the first direction with respect to the supply position. It is sufficient that the first direction is a direction extending parallel to the placement surface. It is sufficient that the gluing unit 300 and the cover sheet holding unit 400 are configured to bind a first end face, which is the end face of the bundle of paper sheets in the first direction, the bundle of paper sheets being the plurality of paper sheets held on the placement surface. The first direction is not limited to the front direction and may be the left direction, the right direction or the rear direction. In the above-described embodiment, a case is exemplified in which the gluing unit 300 and the cover sheet holding unit 400 attach the cover sheet to the first end face using the adhesive. Instead of this, the gluing unit 300 and the cover sheet holding unit 400 may be a mechanism for attaching the cover sheet to the first end face using thread or wire.

It is sufficient that the cutting unit 500 is provided in the second direction with respect to the supply position. It is sufficient that the second direction is a direction opposite to the first direction. It is sufficient that the cutting unit 500 can cut off at least a second end face in the orthogonal direction. The second end face is the end face, in the second direction, of the bundle of paper sheets. The second direction is not limited to the rear direction and may be the left direction, the right direction or the front direction.

In the above-described embodiment, a case is exemplified in which the cutting unit 500 is provided with the rear cutting portion 530 that cuts off the second end face, the left cutting portion 510 that cuts off a third end face, and the right cutting portion 520. The third end face is the end face of the bundle of paper sheets in the third direction that is orthogonal to the orthogonal direction and to the second direction. Instead of this, the cutting unit 500 may be provided with the rear cutting portion 530 only, or may further be provided with one of the left cutting portion 510 and the right cutting portion 520.

(D) It is sufficient that the control portion 900 is a computer (for example, a personal computer, a microcomputer or an application specific integrated circuit (ASIC)) that is configured to perform control relating to at least each of the above-described structures (1) to (19).

(E) In the bookbinding apparatus 1, the layout of the first printer 3, the second printer 4, the paper alignment unit 100, the bundle operation unit 200, the gluing unit 300, the cover sheet holding unit 400 and the cutting unit 500 may be changed. In this case, as exemplified in the above-described embodiment, it is preferable that the first printer 3, the second printer 4, the bundle operation unit 200, the gluing unit 300, the cover sheet holding unit 400 and the cutting unit 500 are arranged centering around the paper alignment unit 100 such that they are each adjacent to the paper alignment unit 100. By doing this, the bookbinding apparatus 1 can inhibit the movement distance of the table 110 that holds the bundle of paper sheets 8 from increasing when performing the bookbinding operations of the book (namely, a series of operations including the forming of the bundle of paper sheets 8, gluing, case binding and cutting). In other words, it is possible to realize the bookbinding apparatus 1 that is provided with each of the above-described mechanisms, with a simple and compact structure.

The apparatus and methods described above with reference to the various embodiments are merely examples. It goes without saying that they are not confined to the depicted embodiments. While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A bookbinding apparatus comprising:
a conveyance portion configured to hold a bundle of paper sheets, the bundle of paper sheets being a plurality of paper sheets stacked in a first direction, and also configured to convey the bundle of paper sheets in a second direction, the second direction being a direction orthogonal to the first direction, and the first direction including a third direction and a fourth direction that are directions opposite to each other;
an adhesive portion forming portion configured to form an adhesive portion on an end face, in the second direction, of the bundle of paper sheets held by the conveyance portion;
a cover sheet supply portion configured to supply a cover sheet that is configured to cover the bundle of paper sheets to a predetermined supply position;
a cover sheet holding portion configured to hold the cover sheet supplied to the supply position by the cover sheet supply portion in a state in which the cover sheet and the adhesive portion formed by the adhesive portion forming portion face each other in the second direction, the cover sheet holding portion including a first holding portion, a second holding portion and a movement portion, the first holding portion being configured to hold the cover sheet supplied to the supply position on the third direction side with respect to a contact position, the second holding portion being provided on the fourth direction side with respect to the first holding portion and being configured to hold the cover sheet supplied to the supply position on the fourth direction side with respect to the contact position, the movement portion being configured to move at least one of the first holding portion and the second holding portion in the first direction, and the contact position being a position where the adhesive portion comes into contact with the cover sheet;
a processor; and
a memory storing computer-readable instructions, the computer-readable instructions, when executed by the processor, causing the processor to perform processes comprising:
causing the conveyance portion to convey the bundle of paper sheets toward the contact position in a state in which the cover sheet is held by the cover sheet holding portion.

2. The bookbinding apparatus according to claim 1, wherein the computer-readable instructions, when executed by the processor, further cause the processor to perform a process of:
positioning the first holding portion on the third direction side with respect to the contact position and positioning the second holding portion on the fourth direction side with respect to the contract position, by causing the movement portion to move at least one of the first holding portion and the second holding portion after the cover sheet is supplied to the supply position and before the bundle of paper sheets reaches the contact position.

3. The bookbinding apparatus according to claim 1, wherein the computer-readable instructions, when executed by the processor, further cause the processor to perform a process of:
causing the first holding portion and the second holding portion to approach each other at the supply position, by causing the movement portion to move at least one of the first holding portion and the second holding portion before the cover sheet is supplied to the supply position.

4. The bookbinding apparatus according to claim 1, wherein the computer-readable instructions, when executed by the processor, further cause the processor to perform processes of:
causing the conveyance portion to convey the bundle of paper sheets from the contact position in the second direction after the bundle of paper sheets is conveyed to the contact position;
causing the holding of the cover sheet by the first holding portion to be released and causing the holding of the cover sheet by the second holding portion to be released when the bundle of paper sheets is conveyed from the contact position in the second direction by the conveyance portion; and
causing the movement portion to move at least one of the first holding portion and the second holding portion in a direction to be separated from the contact position, after the holding of the cover sheet by the first holding portion and the second holding portion is released.

5. The bookbinding apparatus according to claim 1, wherein
the first holding portion includes a first area through which the cover sheet supplied to the supply position can pass, and a first clamp that is configured to clamp a part of the cover sheet that passes through the first area,
the second holding portion includes a second area through which the cover sheet that has passed through the first area can pass, and a second clamp that is configured to clamp a part of the cover sheet that passes through the second area, and
the computer-readable instructions, when executed by the processor, further cause the processor to perform processes of:
causing the second clamp to clamp one end portion of the cover sheet that passes through the second area when the cover sheet is supplied to the supply position, and thereafter causing the first clamp to clamp another end portion of the cover sheet that passes through the first area.

6. The bookbinding apparatus according to claim 1, further comprising:
a guide portion extending in the first direction passing through the contact position and configured to have a length that is equal to or more than a length of the cover sheet in the first direction, the guide portion being configured to guide the first holding portion and the second holding portion in the first direction; and
a restriction portion provided on the third direction side with respect to the contact position and configured to restrict the movement of the first holding portion in the fourth direction,
wherein
the movement portion is configured to move the second holding portion in the first direction along the guide portion, and
the first holding portion is configured to move in the fourth direction to the restriction portion along the guide portion by an external force, and is also configured to move in the third direction from the restriction portion by being pressed by the second holding portion that moves in the third direction.

7. A bookbinding apparatus comprising:
a table having a placement surface which extends in a horizontal direction, the placement surface being configured to hold a bundle of paper sheets on the placement surface, the bundle of paper sheets being the plurality of paper sheets held on the placement surface and stacked in an up-down direction that is orthogonal to the horizontal direction;
a paper alignment portion having a surface portion that extends in the up-down direction, the surface portion being configured to come into contact with an end face of the bundle of paper sheets and being configured to align the end face of the bundle of paper sheets to be in a substantially same plane along the up-down direction within a predetermined area, the end face of the bundle of paper sheets being an end face of the bundle of paper sheets in a first direction that is included in the horizontal direction, the predetermined area being an area along a second direction, the second direction being a direction orthogonal to the up-down direction and to the first direction; and
an application portion configured to form an adhesive portion on the end face of the bundle of paper sheets aligned by the paper alignment portion, by applying an adhesive to the bundle of paper sheets from the first direction side within the predetermined area, the adhesive portion being a portion to which a cover sheet that is configured to cover the bundle of paper sheets can be adhered.

8. The bookbinding apparatus according to claim 7, wherein
the application portion is configured to move along the second direction to a position where the application portion faces the end face of the bundle of paper sheets, from a position that is separated from the end face of the bundle of paper sheets in the second direction, when the application portion applies the adhesive within the predetermined area.

9. The bookbinding apparatus according to claim 7, wherein
the paper alignment portion is configured to separate from the end face of the bundle of paper sheets after the paper alignment portion aligns the end face of the bundle of paper sheets to be in the substantially same plane, and
the application portion is configured to apply the adhesive within the predetermined area after the paper alignment portion is separated from the end face of the bundle of paper sheets.

10. The bookbinding apparatus according to claim 7, further comprising:
a first conveyance portion configured to convey the bundle of paper sheets in the first direction after the adhesive portion is formed by the application portion; and
a cover sheet attaching portion configured to attach the cover sheet to the adhesive portion of the bundle of paper sheets conveyed in the first direction by the first conveyance portion.

11. The bookbinding apparatus according to claim 10, further comprising:
a second conveyance portion configured to convey the bundle of paper sheets in a third direction after the cover sheet is attached to the adhesive portion by the cover sheet adhering portion, the third direction being a direction opposite to the first direction; and
a cutting portion configured to cut the bundle of paper sheets conveyed in the third direction by the second conveyance portion.

12. The bookbinding apparatus according to claim 7, further comprising:
an adhesive receiving portion configured to hold a member below the application portion, a member being configured to receive some of the adhesive that has dropped, of the adhesive that is applied within the predetermined area.

13. The bookbinding apparatus according to claim 7, wherein
the application portion is a movable body that is configured to apply the adhesive within the predetermined area while moving in the second direction over at least a length of the bundle of paper sheets in the second direction.

14. The bookbinding apparatus according to claim 7, wherein
the application portion includes:
a storage portion having a bottomed box shape whose cross-sectional area in the horizontal direction gradually decreases downward, the storage portion being configured to store the adhesive therein;
a mounting portion that is communicatively connected from at least a lower portion of the storage portion to a third direction, the mounting portion being configured such that the adhesive stored in the storage portion flows into the inside of the mounting portion, the third direction being a direction opposite to the first direction;
an application roller that is a substantially cylindrical body that is configured to rotate inside the mounting portion around a shaft that extends in the up-down direction, the application roller having an outer peripheral surface to which the adhesive stored in the storage portion can attach; and
an application opening that is an opening that exposes the outer peripheral surface of the application roller in the third direction from the inside of the mounting portion, and
the predetermined area is an area to which the adhesive can be applied by the outer peripheral surface of the application roller that is exposed from the application opening.

15. A bookbinding apparatus comprising:
a table having a placement surface that is a flat surface configured to hold a bundle of paper sheets, the table being configured to move parallel to the placement surface along a conveyance path, the bundle of paper sheets being a plurality of paper sheets held on the placement surface and stacked in an orthogonal direction that is orthogonal to the placement surface, the conveyance path passing through a supply position where the plurality of paper sheets are supplied to the table, the table being configured to move in a first direction toward a binding position and to move in a second direction toward a cutting position, the first direction being a direction extending parallel to the placement surface, and the second direction being a direction opposite to the first direction;
a binding portion provided on the first direction side with respect to the supply position and configured to bind a first end face, the first end face being an end face of the bundle of paper sheets in the first direction, and the binding position being a position where the first end face is bound by the binding portion; and
a cutting portion provided on the second direction side with respect to the supply position and configured to cut off at least a second end face in the orthogonal direction, the second end face being an end face of the bundle of paper sheets in the second direction, and the cutting position being a position where the second end face is cut off by the cutting portion.

16. The bookbinding apparatus according to claim 15, wherein
the placement surface is a surface which extends in a horizontal direction and on which the plurality of paper sheets are stacked in an up-down direction that is orthogonal to the horizontal direction, and
the table is configured to move in the first direction and the second direction in a state in which the table holds the bundle of paper sheets.

17. The bookbinding apparatus according to claim 15, further comprising:
a conveyance portion configured to move the table from the supply position to the binding position after the plurality of paper sheets are supplied to the table, and configured to move the table from the binding position to the cutting position after the first end face is bound by the binding portion.

18. The bookbinding apparatus according to claim 15, wherein
the binding portion includes:
an adhesive portion forming portion configured to form an adhesive portion on the first end face of the bundle of paper sheets held on the placement surface when the table is in the supply position; and
a cover sheet attaching portion configured to attach a cover sheet that is configured to cover the bundle of paper sheets to the adhesive portion formed by the adhesive portion forming portion when the table is in the binding position.

19. The bookbinding apparatus according to claim 15, wherein
the cutting portion includes:
a first cutting blade that is a blade configured to cut off the second end face; and
a second cutting blade that is a blade configured to cut off a third end face, the third end face being an end face of the bundle of paper sheets in a third direction, the third direction being a direction orthogonal to the orthogonal direction and to the second direction.
